(19) United States
(12) Patent Application Publication
(10) Pub. No.: US 2009/0142680 A1
(43) Pub. Date: Jun. 4, 2009

(54) FULL-COLOR IMAGE FORMING METHOD

(76) Inventors: Naohito SHIMOTA, Numazu-shi (JP); Junichi Awamura, Numazu-shi (JP); Masahide Yamada, Numazu-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 12/271,257

(22) Filed: Nov. 14, 2008

(30) Foreign Application Priority Data
Nov. 29, 2007 (JP) 2007-308315
Sep. 24, 2008 (JP) 2008-243705

(51) Int. Cl. G03G 13/08; G03G 9/09

(52) U.S. Cl. 430/107.1; 430/97

(57) ABSTRACT

A full-color image forming method, including:
developing an electrostatic latent image with a two-component developer, including:
a toner including:
   a binder resin,
   a colorant, and
   a layered inorganic mineral in which ions between its layers are at least partially modified with an organic ion; and
a carrier,
wherein the toner includes a black, a yellow, a magenta and a cyan toner and the carrier is formed of a magnetic particulate material coated with a resin, wherein each of the toners are contained in each toner cartridge comprising the carrier, from which the two-component developer is fed into each image developer developing each of the electrostatic latent image and discharging the extra developer therefrom, and wherein each of the toners has a aerated apparent density not greater than 0.40 and a difference of the aerated apparent density between each of the toners is not greater than 0.10.

### BACKGROUND OF THE INVENTION

1. Field of the Invention

The present invention relates to a toner for use in a developer for developing an electrostatic latent image in electrophotography, electrostatic recording, electrostatic printing, etc., and to an image forming apparatus using the toner. More particularly to a toner for developing an electrostatic image for use in copiers, laser printers, plain paper facsimiles, etc. using a direct or an indirect electrophotographic developing method, and to a developer and an image forming method using the toner.

2. Discussion of the Background

Typically, an electrophotographic image forming apparatus, for example, a printer, a facsimile machine, a copier, a multifunction machine including at least two of these functions, etc., includes a latent image carrier on which an electrostatic latent image is formed, a developing unit to develop the latent image with developer, and a transfer unit to transfer the toner image onto a recording medium, etc. As the developer, two-component developer including toner and carrier is widely used. The developer is periodically replaced because the carrier deteriorates while the developer is repeatedly used. In the image forming industry, a need has arisen to provide high quality images at a lower cost, and a current trend in image quality improvement is reducing particle size of the toner as well as narrowing distribution of the particle size. Regarding toner manufacturing method, because a known pulverization method have limited capabilities to achieve them simultaneously, currently, wet granulation methods as typified by polymerization methods are increasingly used. For example, Japanese published unexamined application No. 2006-343730 discloses a granulation method producing a toner including a colorant and a secondary modified polyester as a binder resin. The secondary modified polyester is produced by linking polyester as a precursor and a primary modified prepolymer including a functional group, such as an isocyanate group, reactive with an active hydrogen group.

The wet granulation methods typically include deformation of toner particles because toner particles produced through granulation are typically spherical, that is, removal thereof from the latent image carrier and the transfer unit are difficult, resulting in image failure.

Further, to reduce the total cost, maintenance cost should be reduced. For example, maintenance cost can be reduced by simplifying replacement of the developer that has deteriorated over time.

To achieve high image quality and reduction in the maintenance cost, Japanese published unexamined application No. 2002-149017 discloses a method called trickle development method. In this method, unused developer is supplied to the developing unit from a supply cartridge containing a mixture of the toner and the carrier, and the deteriorated developer is automatically removed from the developing unit.

In this method, although high image quality can be maintained, toner particles that are produced through a method including deformation using thixotropy of an oil phase, which is achievable at a lower cost, can be differently deformed depending on characteristics of the oil phase of each colorant, causing a bulk density standard to vary from one color to another color.

Therefore, conditions under which the developer is discharged from the developing unit should be adjusted for each color, which increases management cost of components. If the condition are not adjusted for each color, differences in the bulk density will cause image density to vary from one color to another color. Further, image density might be uneven differently for each color, degrading image quality.

Although several approaches such as International publications Nos. WO2004/019137 and WO2004/019138, and Japanese published unexamined application No. 2003-202708 are known regarding charge control of pulverized toner, such as use of monovalent or bivalent metal cation, layered double hydroxide salt including an organic anion A, or an interlayer compound including a cationic surfactant intercalated between layers of a clay mineral as a charge controller, there are no known methods to significantly reduce the difference in apparent bulk density, i.e., 0.10 or less of respective color spherical toner particles, such as chemical toner particles.

Because of these reasons, a need exists for an image forming method producing high-quality images at low cost while maintaining its cleanability.

### SUMMARY OF THE INVENTION

Accordingly, an object of the present invention is to provide an image forming method of producing high-quality images at low cost while maintaining its cleanability.

Another object of the present invention is to provide a full-color toner kit.

These objects and other objects of the present invention, either individually or collectively, have been satisfied by the discovery of a full-color image forming method, comprising:

developing an electrostatic latent image with a two-component developer, comprising:

a toner comprising:
a binder resin,
a colorant, and
a layered inorganic mineral in which ions between its layers are at least partially modified with an organic ion; and

a carrier,

wherein the toner comprises a black, a yellow, a magenta and a cyan toner and the carrier is formed of a magnetic particulate material coated with a resin, wherein each of the toners are contained in each toner cartridge comprising the carrier, from which the two-component developer is fed into each image developer developing each of the electrostatic latent image and discharging the extra developer therefrom, and wherein each of the toners has a aerated apparent density not greater than 0.40 and a difference of the aerated apparent density between each of the toners is not greater than 0.10.

These and other objects, features and advantages of the present invention will become apparent upon consideration of the following description of the preferred embodiments of the present invention taken in conjunction with the accompanying drawings.

### BRIEF DESCRIPTION OF THE DRAWINGS

Various other objects, features and attendant advantages of the present invention will be more fully appreciated as the same becomes better understood from the detailed description when considered in connection with the accompanying drawings in which like reference characters designate like corresponding parts throughout and wherein:

FIG. 1 is a schematic view illustrating an embodiment of the image forming apparatus for use in the present invention;

FIG. 2 is a schematic view illustrating another embodiment of the image forming apparatus for use in the present invention;

FIG. 3 is a schematic view illustrating a further embodiment of the image forming apparatus for use in the present invention; and

FIG. 4 is a schematic enlarged view illustrating a part of the image forming apparatus in FIG. 4.

### DETAILED DESCRIPTION OF THE INVENTION

The present invention provides an image forming method of producing high-quality images, having good cleanability. More particularly, the present invention provides a full-color image forming method, comprising:

developing an electrostatic latent image with a two-component developer, comprising:

a toner comprising:
a binder resin,
a colorant, and
a layered inorganic mineral in which ions between its layers are at least partially modified with an organic ion; and

a carrier,

wherein the toner comprises a black, a yellow, a magenta and a cyan toner and the carrier is formed of a magnetic particulate material coated with a resin, wherein each of the toners are contained in each toner cartridge comprising the carrier, from which the two-component developer is fed into each image developer developing each of the electrostatic latent image and discharging the extra developer therefrom, and wherein each of the toners has a aerated apparent density not greater than 0.40 and a difference or the aerated apparent density between each of the toners is not greater than 0.10.

Namely, conventional toners have an aerated apparent density greater than 0.40 in view of feedability and transportability of the toner in systems. When the shape of a toner is controlled (nonspheronized) as the toner of the present invention, e.g., with a modified layered inorganic mineral such that the toner on a photoreceptor is removed without problem, the inorganic mineral is present at the surface of the toner and the toner has an aerated apparent density not greater than 0.40 due to its cross-interaction. When the aerated apparent density is not greater than 0.40, the variation of the developer bulk density to the variation of aerated apparent density becomes large and an amount of the developer in an image developer largely varies. Namely, when the toner has an aerated apparent density greater than 0.40, quality images cannot be produced, and when not greater than 0.40, quality images can be produced with a toner having good cleanability.

The present invention is most characterized in that each of the toners are contained in a each cartridge comprising the carrier, from which a developer comprising the toner and the carrier are fed into each image developer developing each of the toners and discharging the extra developer therefrom (trickle development), and wherein each of the toners has a aerated apparent density not greater than 0.40 and a difference of the aerated apparent density between each of the toners is not greater than 0.10.

The toner is easily and reliably prepared from a mother toner prepared from a hydrophilic medium including a droplet of toner constituents or their precursor including a layered inorganic mineral in which at least a part of ions between layers is modified with an organic ion.

When the shape of a toner is controlled with a modified layered inorganic mineral such that the toner on a photoreceptor is removed without problem, the inorganic mineral is locally present at the surface of the toner and the toner has an aerated apparent density not greater than 0.40 due to its cross-interaction, which is not preferable the toner to have fluidity.

However, when a difference of the aerated apparent density between each of the toners is not greater than 0.10 at the same time, quality images can be produced even in the trickle development method while the variation of developer density is prevented.

To produce glossy color images having sufficient mixed color, a polyester resin having comparatively a low melting point and good fixability is preferably used. To produce high-definition images, a toner having a small particle diameter and a sharp particle diameter distribution is preferably used.

The toner can be prepared by pulverization methods, however, can preferably be prepared by chemical methods making toner particles from a droplet toner constituents. Such a toner having too high sphericity is likely to escape from the bottom of a cleaning blade and have a problem of its cleanability. Therefore, a toner including a modified layered inorganic mineral at the surface thereof is disclosed to lower the sphericity.

The chemical toner having high sphericity and a sharp particle diameter distribution must preferably be used in the trickle development method in which a developer is transferred much in an image developer. However, when a modified layered inorganic mineral is locally present at the surface of the toner, the toner has an aerated apparent density not greater than 0.40 due to its cross-interaction, which is not preferable the toner to have fluidity. However, when a difference of the aerated apparent density between each of the toners is not greater than 0.10 at the same time, quality images can be produced even in the trickle development method while the variation of developer density is prevented.

When a toner is granulated as an oil phase in an aqueous medium with the layered inorganic mineral, it is dispersed in the oil phase to impart thixotropy to the oil phase and the resultant particles have a sharp particle diameter distribution and are properly deformed. Although the oil phase varies its rheology due to a cross-interaction with a pigment as a colorant and it is difficult to uniform the shapes of all color toners, controlling the dispersion of the layered inorganic mineral enables a controlling of the shape of a toner at low cost.

As mentioned above, large variation of the bulk density of a developer impairs image quality. For example, a developer is highly charged after used in a low-humidity environment and the developer is discharged much and left less in an image developer. When left in a high-humidity environment, the bulk density of the developer lowers and an developer bearer feeds the developer less to a developing area, resulting in deterioration of image density. In such a case, a voltage applied to a photoreceptor and a parameter of developing potential are optimized to prevent deterioration of image quality. However, when the developer in the developing area is too little, halftone images obviously blur. Therefore, full-color images formed of overlapped monochromatic color images deteriorate in quality and the full-color tone partially varies.

As a result of keen studies of the present inventors, it was proved that the surfaceness of a toner granulated from an aqueous medium affects the bulk density of a developer more than a charged quantity of the developer and the bulk density of a carrier.

Besides the dispersion status of the layered inorganic mineral, the content thereof in a toner is important.

For example, in a toner granulated from an aqueous medium, an organic pigment having a hydrophilic group is (1) easy to deform because the oil phase has a large thixotropy, (2) the pigment is likely to be present at an interface between the oil and the aqueous medium and the surfaceness of each color toner largely differs each other when the same layered inorganic mineral is included therein, resulting in a large difference of the aerated apparent density of each color toner.

Particularly, a magenta pigment and a yellow pigment have such tendencies (1) and (2) more than a cyan pigment.

In this case, the surfaceness can be uniformed when the contents of the magenta pigment and/or the yellow pigment are reduced, but the colorization largely deteriorates.

Therefore, when forming full-color images, to produce quality images, controlling the surfaceness of cyan, magenta and yellow toners while maintaining a constant amount of the developer in the image developer, at least the surfaceness thereof needs to be equal and at least the content of the layered inorganic mineral in the magenta toner and/or the yellow toner need to be less than that in the cyan toner.

The developer in a toner cartridge preferably includes a carrier in an amount of from 5 to 20% by weight in consideration of areas of full-color images. When less than 5% by weight, images having large areas deteriorate in quality after produced in large numbers. When greater than 20% by weight, it is not economical because the carrier is provided too much than necessary.

The present invention selects an aqueous phase, an oil phase and a layered inorganic mineral such that the aerated apparent density of each color toner has a specific difference. When the content of the layered inorganic mineral is increased, the aerated apparent density of the toner can be heightened. When decreased, the aerated apparent density thereof can be lowered.

In the present invention, the aerated apparent density of the toner was measured by a powder tester model PTN from Hosokawa Micron Corp. Specifically, 10 g of a sample was placed in a capped measuring cylinder having a capacity of 50 ml, and the cylinder including the sample was shaken by hand for 10 times and left still for 10 min. Then, the toner volume was measured, and which is the aerated apparent density of the toner.

Organic solvents for use in the oil phase preferably have a boiling point lower than 150° C. because they are easy to remove. Specific examples of such solvents include toluene, xylene, benzene, carbon tetrachloride, methylene chloride, 1,2-dichloroethane, 1,1,2-trichloroethane, trichloroethylene, chloroform, monochlorobenzene, dichloroethylidene, methyl acetate, ethyl acetate, methyl ethyl ketone, methyl isobutyl ketone, etc. Among these solvents, aromatic solvents such as toluene and xylene; and halogenated hydrocarbons such as methylenechloride, 1,2-dichloroethane, chloroform, and carbon tetrachloride are preferably used. Particularly, ethyl acetate is more preferably used. These solvents can be used alone or in combination.

The content of such a solvent is preferably from 40 to 300 parts by weight, more preferably from 60 to 140 parts by weight, and furthermore preferably from 80 to 120 parts by weight, per 100 parts by weight of the toner constituents.

The toner constituents includes materials other than a binder resin, a colorant and a modified layered inorganic mineral in which metallic cations are at least partially modified with organic cations if desired. The toner typically includes a monomer, a polymer, a compound having an active hydrogen or a polymer reactive with an active hydrogen as a binder resin and other components such as a release agent if desired.

The modified layered inorganic mineral used as a charge controlling agent will be explained.

The layered inorganic mineral is an inorganic mineral including overlapped layers having a thickness of some nm respectively. Modifying with an organic material ion means introducing an organic material ion into an ion present between the layers, which is called an intercalation in a broad sense and specifically disclosed in WO01/040878 and WO2004/019137, and Japanese published unexamined patent application No. 2003-202708. The layered inorganic minerals include a smectite group such as montmorillonite and saponite; a kaolin group such as kaolinite; magadiite; and kanemite. The modified layered inorganic mineral has high hydrophilicity because of its modified layered structure. Therefore, when the layered inorganic mineral is dispersed without being modified in an aqueous medium to granulate a toner, the layered inorganic mineral passes into the aqueous medium and cannot be dispersed in a toner. The layered inorganic mineral becomes more hydrophobic when modified and is easily dispersed and miniaturized in a toner when granulated to fully perform charge controllability. The toner constituents preferably include the modified layered inorganic mineral in an amount of from 0.05 to 2% by weight.

The modified layered inorganic mineral for use in the present invention is preferably a mineral having a basic smectite crystal structure, which is modified with an organic cation. A part of the bivalent metal of the layered inorganic mineral can be substituted with a trivalent metal to form a metal anion. However, the metal anion has high hydrophilicity and a part thereof is preferably modified with an organic anion.

The organic material ion modifier includes a quaternary alkyl ammonium salt, a phosphonium salt, an imidazolium salt, etc., and the quaternary alkyl ammonium salt is preferably used. Specific examples thereof include trimethylstearylammonium, dimethylstearylbenzylammonium, dimethyloctadecylammonium, oleylbis(2-hydroxylethyl)methylammonium, etc.

The organic material ion modifier further includes sulfate salts having a branched, unbranched or cyclic alkyl group having 1 to 44 carbon atoms, an alkenyl group having 1 to 22 carbon atoms, an alkoxy group having 8 to 32 carbon atoms, a hydroxyalkyl group having 2b to 22 carbon atoms, an ethylene oxide, a propylene oxide, etc.; salts of sulfonic acid; salts of carboxylic acid; or salts of phosphoric acid. A carboxylic acid having an ethylene oxide skeleton is preferably used.

The (modified) layered inorganic mineral partially modified with an organic material ion has appropriate hydrophobicity, and an oil phase including toner constituents and/or a toner constituents precursor has a non-Newtonian viscosity and the resultant toner can be deformed. The toner constituents preferably include the layered inorganic mineral partially modified with an organic material ion in an amount of from 0.05 to 2% by weight.

Specific examples of the (modified) layered inorganic mineral partially modified with an organic material ion include montmorillonite, bentonite, hectolite, attapulgite, sepiolite, their mixtures, etc. Particularly, the organic-modified montmorillonite and bentonite are preferably used because they do not influence upon the resultant toner properties, the viscosity thereof can easily be controlled and a small content thereof works.

Specific examples of marketed products of the layered inorganic mineral partially modified with an organic material cation include Quartanium 18 Bentonite such as Bentone 3, Bentone 38, Bentone 38V, Tixogel VP, Clayton 34, Clayton 40 and Clayton XL; Stearalkonium Bentonite such as Bentone 27, Tixogel LG, Clayton AF and Clayton APA; and Quartanium 18/Benzalkonium Bentonite such as Clayton HT and Clayton PS. Particularly, Clayton AF and Clayton APA are preferably used. In addition, DHT-4A from Kyowa Chemical Industry, Co., Ltd., which is modified with an organic anion having the following formula (1) is preferably used as the layered inorganic mineral partially modified with an organic anion. Specific examples of the organic anion having the following formula (1) include Hitenol 3330T from Dai-ichi Kogyo Seiyaku Co., Ltd.

R₁(OR₂)ₙOSO₃M (1)w

wherein R1 represents an alkyl group having 13 carbon atoms; R₂ represents an alkylene group having 2 to 6 carbon atoms; n represents an integer of from 2 to 10; and m represents a monovalent metallic element.

The modified layered inorganic mineral has appropriate hydrophobicity, and is likely to be locally present at the surf ace of a droplet and the resultant toner has good chargeability.

Specific examples of the colorant for use in the present invention include any known dyes and pigments such as carbon black, Nigrosine dyes, black iron oxide, NAPHTHOL YELLOW S, HANSA YELLOW (10G, 5G and G), Cadmium Yellow, yellow iron oxide, loess, chrome yellow, Titan Yellow, polyazo yellow, Oil Yellow, HANSA YELLOW (GR, A, RN and R), Pigment Yellow L, BENZIDINE YELLOW (G and GR), PERMANENT YELLOW (NCG), VULCAN FAST YELLOW (5G and R), Tartrazine Lake, Quinoline Yellow Lake, ANTHRAZANE YELLOW BGL, isoindolinone yellow, rediron oxide, red lead, orange lead, cadmium red, cadmium mercury red, antimony orange, Permanent Red 4R, Para Red, Fire Red, p-chloro-o-nitroaniline red, Lithol Fast Scarlet G, Brilliant Fast Scarlet, Brilliant Carmine BS, PERMANENT RED (F2R, F4R, FRL, FRLL and F4RH), Fast Scarlet VD, VULCAN FAST RUBINE B, Brilliant Scarlet G, LITHOL RUBINE GX, Permanent Red F5R, Brilliant Carmine 6B, Pigment Scarlet 3B, Bordeaux 5B, Toluidine Maroon, PERMANENT BORDEAUX F2K, HELIO BORDEAUX BL, Bordeaux 10B, BON MAROON LIGHT, BON MAROON MEDIUM, Eosin Lake, Rhodamine Lake B, Rhodamine Lake Y, Alizarine Lake, Thioindigo Red B, Thioindigo Maroon, Oil Red, Quinacridone Red, Pyrazolone Red, polyazo red, Chrome Vermilion, Benzidine Orange, perynone orange, Oil Orange, cobalt blue, cerulean blue, Alkali Blue Lake, Peacock Blue Lake, Victoria Blue Lake, metal-free Phthalocyanine Blue, Phthalocyanine Blue, Fast Sky Blue, INDANTHRENE BLUE (RS and BC), Indigo, ultramarine, Prussian blue, Anthraquinone Blue, Fast Violet B, Methyl Violet Lake, cobalt violet, manganese violet, dioxane violet, Anthraquinone Violet, Chrome Green, zinc green, chromium oxide, viridian, emerald green, Pigment Green B, Naphthol Green B, Green Gold, Acid Green Lake, Malachite Green Lake, Phthalocyanine Green, Anthraquinone Green, titanium oxide, zinc oxide, lithopone and their combinations. In addition, pigment red such as PR122, PR269, PR184, PR57:1, PR238, PR146and PR185; pigment yellow such as PY93, PY128, PY155, PY180 and PY74; pigment blue such as PB15:3; etc. can also be used. These can be used alone or in combination.

The colorant may be dispersed alone or with a binder resin in a solvent to prepare a dispersion, and the viscosity of the dispersion may be controlled upon application of shearing strength with the resin.

The colorant preferably has a dispersion particle diameter not greater than 1 μm. When greater than 1 μm, the resultant toner occasionally produces poor quality images, particularly OHP sheets printed thereby occasionally have poor light transmission.

The dispersion diameter of a colorant can be measured by MICROTRAC ultra fine particle diameter distribution measurer UPA-EX150 using laser Doppler method from Nikkiso Co., Ltd.

The toner preferably includes a colorant in an amount of from 1 to 15% by weight, and more preferably from 3 to 10% by weight. When less than 1% by weight, the toner deteriorates in its colorability. When greater than 15% by weight, the colorant is not dispersed well in a toner, and which occasionally deteriorates in its colorability and electrical properties.

In the present invention, the aqueous medium preferably includes a polymeric dispersant. The polymeric dispersant is preferably a water-soluble polymer. Specific examples of the water-soluble polymer include carboxy methyl cellulose sodium, hydroxy ethyl cellulose, polyvinylalcohol, etc. These can be used alone or in combination.

The disperser is not particularly limited, and low-speed shearing dispersers, high-speed shearing dispersers, friction dispersers, high-pressure jet dispersers, ultrasonic dispersers, etc. can be used. Among these methods, high-speed shearing dispersers are preferably used because particles having a particle diameter of from 2 to 20 μm can be easily prepared. When a high-speed shearing disperser is used, the rotation speed is not particularly limited, but the rotation speed is typically from 1,000 to 30,000 rpm, and preferably from 5,000 to 20,000 rpm. The dispersion time is not also particularly limited, but is typically from 0.1 to 5 minutes. The temperature in the dispersion process is typically from 0 to 150° C. (under pressure), and preferably from 40 to 98° C.

Mother toner particles can be formed by known methods. Specific examples thereof include methods such as a suspension polymerization method, an emulsion polymerization agglutination method and a solution suspension method; and a method of forming mother toner particles while producing an adhesive base material. Among these methods, the method of forming mother toner particles while producing an adhesive base material is preferably used. The adhesive base material has adhesiveness to a recording medium such as a paper.

The method of forming mother toner particles while producing an adhesive base material includes reacting a compound including a group having an active hydrogen with a polymer reactable therewith un an aqueous medium. In addition, the adhesive base material may optionally include a binder resin besides these.

The mother toner particles preferably includes a colorant, and may optionally include a release agent, a charge controlling agent and other components.

The adhesive base material preferably has a peak molecular weight not less than 3,000, more preferably from 5,000 to 1,000,000, and much more preferably from 7,000 to 500,000. When less than 3,000, the hot offset resistance of the resultant toner occasionally deteriorates.

The adhesive base material preferably has glass transition temperature of from 30 to 70° C., and more preferably from 40 to 65° C. When lower than 30° C., the resultant toner occasionally deteriorates in its thermostable preservability. When higher than 70° C., the resultant toner occasionally deteriorates in its low-temperature fixability. A toner including a crosslinked or elongated polyester resin as an adhesive base material has good preservability even when having a low glass transition temperature.

Specific examples of the adhesive base material include polyester resins.

Specific examples of the polyester resins include urea-modified polyester resins.

The urea-modified polyester resins are formed from a reaction between amines (B) as the compound including group having an active hydrogen and a polyester prepolymer including an isocyanate group (A) as the polymer reactable therewith in the aqueous medium.

The urea-modified polyester resins may include a urethane bonding as well as a urea bonding. A molar ratio (urea/urethane) of the urea bonding to the urethane bonding is from 100/0 to 10/90, preferably from 80/20 to 20/80 and more preferably from 60/40 to 30/70. When the urea bonding has a molar ratio less than 10%, hot offset resistance of the resultant toner deteriorates.

Specific examples of adhesive base material include (1) a mixture of a urea-modified polyester prepolymer with isophoronediamine, which is formed from a reacting a polycondensate of an adduct of bisphenol A with 2 moles of ethyleneoxide and an isophthalic acid with isophoronediisocyanate; and a polycondensate of an adduct of bisphenol A with 2 moles of ethyleneoxide and an isophthalic acid, (2) a mixture of a urea-modified polyester prepolymer with isophoronediamine, which is formed from a reacting a polycondensate of an adduct of bisphenol A with 2 moles of ethyleneoxide and an isophthalic acid with isophoronediisocyanate; and a polycondensate of an adduct of bisphenol A with 2 moles of ethyleneoxide and a terephthalic acid, (3) a mixture of a urea-modified polyester prepolymer with isophoronediamine, which is formed from a reacting a polycondensate of an adduct of bisphenol A with 2 moles of ethyleneoxide/an adduct of bisphenol A with 2 moles of propyleneoxide and an terephthalic acid with isophoronediisocyanate; and a polycondensate of an adduct of bisphenol A with 2 moles of ethyleneoxide/an adduct of bisphenol A with 2 moles of propyleneoxide and a terephthalic acid, (4) a mixture of a urea-modified polyester prepolymer with isophoronediamine, which is formed from a reacting a polycondensate of an adduct of bisphenol A with 2 moles of ethyleneoxide/an adduct of bisphenol A with 2 moles of propyleneoxide and an terephthalic acid with isophoronediisocyanate; and a polycondensate of an adduct of bisphenol A with 2 moles of propyleneoxide and a terephthalic acid, (5) a mixture of a urea-modified polyester prepolymer with hexamethylenediamine, which is formed from a reacting a polycondensate of an adduct of bisphenol A with 2 moles of ethyleneoxide and an terephthalic acid with isophoronediisocyanate; and a polycondensate of an adduct of bisphenol A with 2 moles of ethyleneoxide and a terephthalic acid, (6) a mixture of a urea-modified polyester prepolymer with hexamethylenediamine, which is formed from a reacting a polycondensate of an adduct of bisphenol A with 2 moles of ethyleneoxide and an terephthalic acid with isophoronediisocyanate; and a polycondensate of an adduct of bisphenol A with 2 moles of ethyleneoxide/an adduct of bisphenol A with 2 moles of propyleneoxide and a terephthalic acid, (7) a mixture of a urea-modified polyester prepolymer with ethylenediamine, which is formed from a reacting a polycondensate of an adduct of bisphenol A with 2 moles of ethyleneoxide and an terephthalic acid with isophoronediisocyanate; and a polycondensate of an adduct of bisphenol A with 2 moles of ethyleneoxide and a terephthalic acid, (8) a mixture of a urea-modified polyester prepolymer with hexamethylenediamine, which is formed from a reacting a polycondensate of an adduct of bisphenol A with 2 moles of ethyleneoxide and an isophthalic acid with diphenylmethanediisocyanate; and a polycondensate of an adduct of bisphenol A with 2 moles of ethyleneoxide and an isophthalic acid, (9) a mixture of a urea-modified polyester prepolymer with hexamethylenediamine, which is formed from a reacting a polycondensate of an adduct of bisphenol A with 2 moles of ethyleneoxide/an adduct of bisphenol A with 2 moles of propyleneoxide and an terephthalic acid/dodecenylsuccinic acid anhydride with diphenylmethanediisocyanate; and a polycondensate of an adduct of bisphenol A with 2 moles of ethyleneoxide/an adduct of bisphenol A with 2 moles of propyleneoxide and a terephthalic acid, and (10) a mixture of a urea-modified polyester prepolymer with hexamethylenediamine, which is formed from a reacting a polycondensate of an adduct of bisphenol A with 2 moles of ethyleneoxide and an isophthalic acid with toluenediisocyanate; and a polycondensate of an adduct of bisphenol A with 2 moles of ethyleneoxide and an isophthalic acid.

The compound including a group having an active hydrogen performs as an elongator or a crosslinker when the polymer reactable therewith is subject to an elongation or crosslinking reaction in the aqueous medium.

Specific examples of the a group having an active hydrogen include hydroxyl groups such as an alcoholic hydroxyl group and a phenolic hydroxyl group, an amino group, a carboxyl group, a mercapto group, etc. These can be used alone or in combination.

Specific examples of the compound including a group having an active hydrogen include amines (B) when the polymer reactable therewith is the polyester prepolymer including an isocyanate group because of being polymerizable from an elongation or a crosslinking reaction with the polyester prepolymer including an isocyanate group.

Specific examples of the amines (B) include diamines (B1), polyamines (B2) having three or more amino groups, amino alcohols (B3), amino mercaptans (B4), amino acids (B5) and blocked amines (B6) in which the amino groups in the amines (B1) to (B5) are blocked. These can be used alone or in combination.

Specific examples of the diamines (B1) include aromatic diamines such as phenylene diamine, diethyltoluene diamine and 4,4′-diaminodiphenyl methane; alicyclic diamines such as 4,4′-diamino-3,3′-dimethyldicyclohexyl methane, diaminocyclohexane and isophoronediamine; aliphatic diamines such as ethylene diamine, tetramethylene diamine and hexamethylene diamine. Specific examples of the polyamines (B2) having three or more amino groups include diethylene triamine, triethylene tetramine, etc. Specific examples of the amino alcohols (B3) include ethanol amine, hydroxyethyl aniline, etc. Specific examples of the amino mercaptan (B4) include aminoethyl mercaptan, aminopropyl mercaptan, etc. Specific examples of the amino acids (B5) include amino propionic acid, amino caproic acid, etc. Specific examples of the blocked amines (B6) include ketimine compounds which are prepared by reacting one of the amines (B1) to (B5) with a ketone such as acetone, methyl ethyl ketone and methyl isobutyl ketone; oxazoline compounds, etc.

A reaction terminator can be used to terminate the elongation or crosslinking reaction between the compound including a group having an active hydrogen and the polymer reactable therewith. The reaction terminator is preferably used to control the molecular weight of the adhesive base material. Specific examples of the reaction terminator include monoamines such as diethyle amine, dibutyl amine, butyl amine and lauryl amine, and blocked amines, i.e., ketimine compounds prepared by blocking the monoamines mentioned above.

A mixing ratio, i.e., a ratio [NCO]/[NHx] of the isocyanate group [NCO] in the prepolymer (A) to the amino group [NHx] in the amine (B) is preferably from 1/3 to 3/1, and more preferably from 1/2 to 2/1. When the mixing ratio ([NCO]/[NHx]) is less than 1/3, the low-temperature fixability of the resultant toner occasionally deteriorates. When greater than 3/1, the hot offset resistance thereof occasionally deteriorates.

The polymer reactable with the compound having a group including an active hydrogen (hereinafter referred to as a “prepolymer”) is not particularly limited, and can be selected from known resins. Specific examples thereof include a polyol resins, a polyacrylic resin, a polyester resin, an epoxy resin, their derivatives, etc. Among these resins, the polyester resin having high fluidity when melting and transparency is preferably used. These can be used alone or in combination.

Functional groups reactable with the compound having a group including an active hydrogen include an isocyanate group, an epoxy group, a carboxyl group, a group having —COCl, etc. among these groups, the isocyanate group is preferably used. These can be used alone or in combination.

Among the prepolymers, a polyester resin having an isocyanate group capable of forming a urea bonding is preferably used because of being capable of controlling the molecular weight of the polymer components, imparting oilless low-temperature fixability to a dry toner, and good releasability and fixability thereto even in an apparatus without a release oil applicator to a heating medium for fixing.

The polyester prepolymer including an isocyanate group is not particularly limited, and can be selected in accordance with the purpose. For example, the polyester prepolymers including an isocyanate group can be prepared by reacting a polycondensation product of a polyol and a polycarboxylic acid, i.e., a polyester resin having a group including an active hydrogen atom, with a polyisocyanate.

The polyol is not particularly limited, and can be selected in accordance with the purpose. For example, suitable polyols include diols, polyols having three or more hydroxyl groups, and mixtures of diols and polyols having three or more hydroxyl groups. These can be used alone or in combination.

Specific examples of the diols include alkylene glycols, alkylene ether glycols, alicyclic diols, bisphenols, alkylene oxide adducts of alicyclic diols, alkylene oxide adducts of bisphenols, etc.

Specific examples of the alkylene glycols include ethylene glycol, 1,2-propylene glycol, 1,3-propylene glycol, 1,4-butanediol and 1,6-hexanediol. Specific examples of the alkylene ether glycols include diethylene glycol, triethylene glycol, dipropylene glycol, polyethylene glycol, polypropylene glycol and polytetramethylene ether glycol. Specific examples of the alicyclic diols include 1,4-cyclohexanedimethanol and hydrogenated bisphenol A. Specific examples of the bisphenols include bisphenol A, bisphenol F and bisphenol S. Specific examples of the alkylene oxide adducts of alicyclic diols include adducts of the alicyclic diols mentioned above with an alkylene oxide (e.g., ethylene oxide, propylene oxide and butylene oxide). Specific examples of the alkylene oxide adducts of bisphenols include adducts of the bisphenols mentioned above with an alkylene oxide (e.g., ethylene oxide, propylene oxide and butylene oxide).

Among these compounds, alkylene glycols having from 2 to 12 carbon atoms and adducts of bisphenols with an alkylene oxide are preferably used, and adducts of bisphenols with an alkylene oxide, and mixtures of an adduct of bisphenols with an alkylene oxide and an alkylene glycol having from 2 to 12 carbon atoms are more preferably used.

Specific examples of the polyols having three or more hydroxyl groups include multivalent aliphatic alcohol having 3 to 8 or more valences such as glycerin, trimethylolethane, trimethylolpropane, pentaerythritol and sorbitol; phenol having 3 or more valences such as trisphenol PA, phenolnovolak, cresolnovolak; and adducts of the above-mentioned polyphenol having 3 or more valences with an alkylene oxide such as ethylene oxide, propylene oxide and butylene oxide.

A mixing ratio of the polyols having three or more hydroxyl groups to the diols is preferably 0.01 to 10% by weight, and more preferably 0.01 to 1% by weight.

Specific examples of the polycarboxylic acids include dicarboxylic acids and polycarboxylic acids having three or more carboxyl groups. These can be used alone or in combination.

Specific examples of the dicarboxylic acids include alkylene dicarboxylic acids (e.g., succinic acid, adipic acid and sebacic acid); alkenylene dicarboxylic acids (e.g., maleic acid and fumaric acid); aromatic dicarboxylic acids (e.g., phthalic acid, isophthalic acid, terephthalic acid and naphthalene dicarboxylic acids; etc. Among these compounds, alkenylene dicarboxylic acids having from 4 to 20 carbon atoms and aromatic dicarboxylic acids having from 8 to 20 carbon atoms are preferably used.

Specific examples of the polycarboxylic acid having three or more hydroxyl groups include aromatic polycarboxylic acids having from 9 to 20 carbon atoms (e.g., trimellitic acid and pyromellitic acid).

Anhydrides or lower alkyl esters (e.g., methyl esters, ethyl esters or isopropyl esters) of the dicarboxylic acids, the polycarboxylic acids having three or more hydroxyl groups or their mixture can also be used as the polycarboxylic acid. Specific examples of the lower alkyl esters include a methyl ester, an ethyl ester, an isopropyl ester, etc.

A mixing ratio of the polycarboxylic acids having three or more hydroxyl groups to the dicarboxylic acids is preferably from 0.01 to 10% by weight, and more preferably from 0.01 to 1% by weight.

Suitable mixing ratio (i.e., the equivalence ratio [OH]/[COOH]) of the [OH] group of a polyol to the [COOH] group of a polycarboxylic acid is typically from 1 to 2, preferably from 1 to 1.5, and more preferably from 1.02 to 1.3.

The polyester prepolymer including an isocyanate group preferably includes the polyol in an amount of from 0.5 to 40% by weight, more preferably from 1 to 30% by weight, and even more preferably from 2 to 20% by weight. When less than 0.5% by weight, the hot offset resistance of the resultant toner deteriorates, which is difficult to have both thermostable preservability and low-temperature fixability. When greater than 40% by weight, the low-temperature fixability thereof deteriorates.

Specific examples of the polyisocyanates include aliphatic polyisocyanates such as tetramethylenediisocyanate, hexamethylenediisocyanate, 2,6-diisocyanatemethylcaproate, octamethylenediisocyanate, decamethylenediisocyanate, dodecamethylenediisocyanate, tetradecamethylenediisocyanate and trimethylhexanediisocyanate; alicyclic polyisocyanates such as isophoronediisocyanate and cyclohexylmethanediisocyanate; aromatic diisocianates such as tolylene diisocyanate, diphenylmethane diisocyanate, 1,5-naphthylene diisocyanate, diphenylene-4,4′-diisocyanate, 4,4′-diisocyanate-3,3-dimethyl diphenyl, 3-methyldiphenylmethane-4,4′-diisocynate and diphenylether-4,4′-diisocyanate; aromatic aliphatic diisocyanates such as α,α,α′,α′-tetramethylxylylenediisocyanate; isocyanurates such as tris-isocyanatealkyl-isocyanurate and triisocyanatecycloalkyl-isocyanurate; blocked polyisocyanates in which the polyisocyanates mentioned above are blocked with phenol derivatives, oximes or caprolactams; etc. These compounds can be used alone or in combination.

Suitable mixing ratio (i.e., the equivalence ratio [NCO]/[OH]) of the [NCO] group of the polyisocyanate to the [OH] group of the polyester resin having a group including an active hydrogen (such as a polyester resin including a hydroxyl group) is preferably from 1 to 5, more preferably from 1.2 to 4 and even more preferably from 1.5 to 3. When greater than 5, the low-temperature fixability of the resultant toner deteriorates. When less than 1, the offset resistance thereof deteriorates.

The polyester prepolymer including an isocyanate group preferably includes the polyisocyanate in an amount of from 0.5 to 40% by weight, more preferably from 1 to 30% by weight, and even more preferably from 2 to 20% by weight. When less than 0.5% by weight, the hot offset resistance of the resultant toner deteriorates, which is difficult to have both thermostable preservability and low-temperature fixability. When greater than 40% by weight, the low-temperature fixability thereof deteriorates.

An average number of the isocyanate group included in the polyester prepolymer including an isocyanate group per molecule is preferably not less than 1, more preferably from 1.2 to 5, and even more preferably from 1.5 to 4. When less than 1, the polyester resin including a group formed by urea bonding has a lower molecular weight, and the hot offset resistance of the resultant toner occasionally deteriorates.

Specific examples of the binder resins include a polyester resin. Particularly an unmodified polyester resin is preferably used. The unmodified polyester resin included in a toner improves the low-temperature fixability thereof and glossiness of images produced thereby.

The unmodified polyester resin includes the examples of the polyester resin including a group formed by urea bonding, i.e., the polycondensated products between the PO and PC. It is preferable that the unmodified polyester resin is partially compatible with the polyester resin including a group formed by urea bonding, i.e., these have a compatible similar structure because the resultant toner has good low-temperature fixability and hot offset resistance.

The unmodified polyester resin preferably have a weight-average molecular weight (Mw) of from 1,000 to 30,000, and more preferably from 1,500 to 15,000. When less than 1,000, the thermostable preservability of the resultant toner occasionally deteriorates, and therefore the content of the unmodified polyester resin having weight-average molecular weight (Mw) less than 1,000 needs to be 8 to 28% by weigh. When greater than 30,000, the low-temperature fixability thereof occasionally deteriorates.

The unmodified polyester resin preferably has a glass transition temperature of from 30 to 70° C., more preferably from 35 to 60° C., and even more preferably from 35 to 50° C. When less than 30° C., the thermostable preservability of the resultant toner occasionally deteriorates. When greater than 70° C., the low-temperature fixability thereof occasionally deteriorates.

The unmodified polyester resin preferably has a hydroxyl value not less than 5 KOH mg/g, more preferably from 10 to 120 KOH mg/g, and even more preferably from 20 to 80 KOH mg/g. When less than 5 KOH mg/g, the resultant toner is occasionally difficult to have both thermostable preservability and low-temperature fixability.

The unmodified polyester resin preferably has an acid value of from 1.0 to 50.0 KOH mg/g, and more preferably from 1.0 to 30.0 KOH mg/g. The resultant toner having such an acid value is likely to be negatively charged.

A mixing ratio by weight of the polyester prepolymer having an isocyanate group to the unmodified polyester resin is preferably from 5/95 to 25/75, and more preferably from 10/90 to 25/75. When less than 5/95, the hot offset resistance of the resultant toner occasionally deteriorates. When greater than 25/75, the low-temperature fixability and the glossiness thereof occasionally deteriorate.

The toner of the present invention may further include a release agent, a charge controlling agent, a particulate resin, an inorganic particulate material, a fluidity improver, a cleanability improver, a magnetic material, a metallic salts, etc.

Specific examples of the release agent include waxes, e.g., polyolefin waxes such as polyethylene wax and polypropylene wax; long chain carbon hydrides such as paraffin wax and sasol wax; and waxes including carbonyl groups. These can be used alone or in combination. Among these waxes, the waxes including carbonyl groups are preferably used.

Specific examples thereof include polyesteralkanate such as carnauba wax, montan wax, trimethylolpropanetribehenate, pentaelislitholtetrabehenate, pentaelislitholdiacetatedibehenate, glycerinetribehenate and 1,18-octadecanedioldistearate; polyalkanolesters such as tristearyltrimellitate and distearylmaleate; polyamidealkanate such as ethylenediaminebehenylamide; polyalkylamide such as tristearylamidetrimellitate; and dialkylketone such as distearylketone.

The wax preferably has a melting point of from 40 to 160° C., more preferably of from 50 to 120° C., and much more preferably of from 60 to 90° C. A wax having a melting point less than 40° C. has an adverse effect on its high temperature preservability, and a wax having a melting point greater than 160° C. tends to cause cold offset of the resultant toner when fixed at a low temperature.

In addition, the wax preferably has a melting viscosity of from 5 to 1,000 cps, and more preferably of from 10 to 1,000 cps when measured at a temperature higher than the melting point by 20° C. A wax having a melting viscosity greater than 1,000 cps occasionally makes it difficult to improve hot offset resistance and low temperature fixability of the resultant toner.

The content of the wax in a toner is preferably from 0 to 40% by weight, and more preferably from 3 to 30% by weight. When greater than 40% by weight, the fluidity of the toner occasionally deteriorates.

Any known thermoplastic or thermosetting resins which can form a dispersion in an aqueous medium can be used as the particulate resin. Specific examples thereof include a vinyl resin, a polyurethane resins, an epoxy resins, a polyester resin, a polyamide resin, a polyimide resin, a silicone resin, a phenolic resin, a melamine resin, a urea resin, an aniline resin, an ionomer resin, a polycarbonate resins, etc. These resins can be used alone or in combination. Among these resins, at least one of the vinyl resins, the polyurethane resins, the epoxy resins and the polyester resins are preferably used because an aqueous dispersion including a microscopic spherical particulate resin can easily be prepared with the resin.

Specific examples of the vinyl resins include homopolymerized or copolymerized polymers such as styrene-(metha)esteracrylate resins, styrene-butadiene copolymers, (metha)acrylic acid-esteracrylate polymers, styrene-acrylonitrile copolymers, styrene-maleic acid anhydride copolymers and styrene-(metha)acrylic acid copolymers.

As the particulate resin, a copolymer including a monomer having at least two unsaturated groups can also be used. The monomer having at least two unsaturated groups is not particularly limited, and can be selected in accordance with the purpose. Specific examples thereof include a sodium salt of a sulfate ester with an additive of ethylene oxide methacrylate (ELEMINOL RS-30 from Sanyo Chemical Industries, Ltd.), divinylbenzene, 1,6-hexanediolacrylate, etc.

The particulate resin can be prepared by any known polymerization methods, however, preferably prepared in the form of an aqueous dispersion thereof. The aqueous dispersion thereof can be prepared by the following methods:

(1) a method of directly preparing an aqueous dispersion of a vinyl resin from a vinyl monomer by a suspension polymerization method, an emulsification polymerization method, a seed polymerization method or a dispersion polymerization method;

(2) a method of preparing an aqueous dispersion of polyaddition or polycondensation resins such as a polyester resin, a polyurethane resin and an epoxy resin by dispersing a precursor (such as a monomer and an oligomer) or a solution thereof in an aqueous medium under the presence of a dispersant to prepare a dispersion, and heating the dispersion or adding a hardener thereto to harden the dispersion;

(3) a method of preparing an aqueous dispersion of polyaddition or polycondensation resins such as a polyester resin, a polyurethane resin and an epoxy resin by dissolving an emulsifier in a precursor (such as a monomer and an oligomer) or a solution (preferably a liquid or may be liquefied by heat) thereof to prepare a solution, and adding water thereto to subject the solution to a phase-inversion emulsification;

(4) a method of pulverizing a resin prepared by any polymerization methods such as addition condensation, ring scission polymerization, polyaddition and condensation polymerization with a mechanical or a jet pulverizer to prepare a pulverized resin and classifying the pulverized resin to prepare a particulate resin, and dispersing the particulate resin in an aqueous medium under the presence of a dispersant;

(5) a method of spraying a resin solution wherein a resin prepared by any polymerization methods such as addition condensation, ring scission polymerization, polyaddition and condensation polymerization is dissolved in a solvent to prepare a particulate resin, and dispersing the particulate resin in an aqueous medium under the presence of a dispersant;

(6) a method of adding a lean solvent in a resin solution wherein a resin prepared by any polymerization methods such as addition condensation, ring scission polymerization, polyaddition and condensation polymerization is dissolved in a solvent, or cooling a resin solution wherein the resin is dissolved upon application of heat in a solvent to separate out a particulate resin and removing the solvent therefrom, and dispersing the particulate resin in an aqueous medium under the presence of a dispersant;

(7) a method of dispersing a resin solution, wherein a resin prepared by any polymerization methods such as addition condensation, ring scission polymerization, polyaddition and condensation polymerization is dissolved in a solvent, in an aqueous medium under the presence of a dispersant, and removing the solvent upon application of heat or depressure; and

(8) a method of dissolving an emulsifier in a resin solution wherein a resin prepared by any polymerization methods such as addition condensation, ring scission polymerization, polyaddition and condensation polymerization is dissolved in a solvent, and adding water thereto to subject the solution to a phase-inversion emulsification.

Specific examples of the inorganic particulate material include silica, alumina, titanium oxide, barium titanate, magnesium titanate, calcium titanate, strontium titanate, zinc oxide, tin oxide, quartz sand, clay, mica, sand-lime, diatom earth, chromium oxide, cerium oxide, red iron oxide, antimony trioxide, magnesium oxide, zirconium oxide, barium sulfate, barium carbonate, calcium carbonate, silicon carbide, silicon nitride, etc.

The inorganic particulate material preferably has a primary particle diameter of from 5 nm to 2 μm, and more preferably from 5 to 500 nm. The inorganic particulate material preferably has a specific surface area of from 20 to 500 m²/g when measured by a BET nitrogen absorption method.

The inorganic particulate material is preferably included in a toner in an amount of from 0.01 to 5% by weight, and more preferably from 0.01 to 2.0% by weight based on total weight of the toner.

The toner can be surface-treated with the fluidity improver to increase the hydrophobicity to prevent deterioration of fluidity and chargeability even in an environment of high humidity. Specific examples of the surface treatment agent include a silane coupling agent, a sililating agents a silane coupling agent having an alkyl fluoride group, an organic titanate coupling agent, an aluminum coupling agent a silicone oil and a modified silicone oil.

The toner may include the cleanability improver for removing a developer remaining on a photoreceptor and a first transfer medium after transferred. Specific examples of the cleanability improver include fatty acid metallic salts such as zinc stearate, calcium stearate and stearic acid; and polymer particulate materials prepared by a soap-free emulsifying polymerization method such as a polymethylmethacrylate particulate material and a polystyrene particulate material. The polymer particulate materials comparatively have a narrow particle diameter distribution and preferably have a volume-average particle diameter of from 0.01 to 1 μm.

An embodiment of the method of preparing a toner by granulating the adhesive base material will be explained. The method includes preparation of the aqueous medium, preparation of the solution or dispersion of the toner constituents, emulsification or dispersion of the solution or dispersion of the toner constituents in the aqueous medium, production of a binder resin formed of the reaction between the compound having a group including an active hydrogen and the polymer reactable therewith, removal of the organic solvent, synthesis of the polymer reactable with the compound having a group including an active hydrogen (prepolymer), synthesis of the compound having a group including an active hydrogen, etc.

The particulate resin is dispersed in the aqueous medium. The aqueous medium preferably includes the particulate resin in an amount of from 0.5 to 10% by weight.

The solution or dispersion of the toner constituents can be prepared by dissolving or dispersing toner constituents such as a compound having a group including an active hydrogen, a polymer reactable therewith, a rheology additive, a colorant, a release agent, a charge controlling agent and an unmodified polyester resin in the organic solvent.

Thee toner constituents besides the polymer reactable with the compound having a group including an active hydrogen (prepolymer) maybe added the aqueous medium when the particulate resin is dispersed therein or when the solution or dispersion of the toner constituents is added to the aqueous medium.

When the solution or dispersion of the toner constituents is emulsified or dispersed in the aqueous medium, the compound having a group including an active hydrogen and the polymer reactable therewith are subjected to an elongation or crosslinking reaction to produce the adhesive base material.

The adhesive base material such as the urea-modified polyester resin may be produced by emulsifying or dispersing the solution or dispersion of the toner constituents including the polymer reactable with the compound having a group including an active hydrogen such as the prepolymer including an isocyanate group with the compound having a group including an active hydrogen such as the amines in the aqueous medium to be subjected to an elongation or a crosslinking reaction; emulsifying or dispersing the solution or dispersion of the toner constituents in the aqueous medium previously including the compound having a group including an active hydrogen to be subjected to an elongation or a crosslinking reaction; or emulsifying or dispersing the solution or dispersion of the toner constituents in the aqueous medium, and adding the compound having a group including an active hydrogen thereto to be subjected to an elongation or a crosslinking reaction, wherein the modified polyester is preferentially formed on the surface of the toner, which can have a concentration gradient thereof.

The reaction time of the elongation or crosslinking reaction between the compound having a group including an active hydrogen and the polymer reactable therewith is preferably from 10 min to 40 hrs, and more preferably from 2 to 24 hrs. The reaction temperature is preferably from 0 to 150° C., and more preferably from 40 to 98° C.

Methods of stably forming the dispersion including the polymer reactable with the compound having a group including an active hydrogen, such as the polyester prepolymer including an isocyanate group in the aqueous medium include, e.g., a method of adding the solution or dispersion prepared by dissolving or dispersing the polymer reactable with the compound having a group including an active hydrogen such as the polyester prepolymer including an isocyanate group, the colorant, the release agent, the charge controlling agent and the unmodified polyester resin in the organic solvent, into the aqueous medium, and dispersing the solution or dispersion therein with a shearing force.

The dispersion method is not particularly limited, and known mixers and dispersers such as a low shearing-force disperser, a high shearing-force disperser, a friction disperser, a high-pressure jet disperser and an ultrasonic disperser can be used. In order to prepare the toner for use in the present invention, it is preferable to prepare an emulsion including particles having an average particle diameter of from 2 to 20 μm. Therefore, the high shearing-force disperser is preferably used.

When the high shearing-force disperser is used, the rotation speed of rotors thereof is not particularly limited, but the rotation speed is typically from 1,000 to 30,000 rpm, and preferably from 5,000 to 20,000 rpm. In addition, the dispersion time is also not particularly limited, but the dispersion time is typically from 0.1 to 5 minutes. The temperature in the dispersion process is typically 0 to 150° C. (under pressure), and preferably from 40 to 98° C. The processing temperature is preferably as high as possible because the viscosity of the dispersion decreases and thereby the dispersing operation can be easily performed.

The content of the aqueous medium to 100 parts by weight of the toner constituent liquid is typically from 50 to 2,000 parts by weight, and preferably from 100 to 1,000 parts by weight. When the content is less than 50 parts by weight, the dispersion of the toner constituents in the aqueous medium is not satisfactory, and thereby the resultant mother toner particles do not have a desired particle diameter. In contrast, when the content is greater than 2,000, the production cost increases.

Before the toner constituents solution or dispersion is dispersed in the aqueous medium, a dispersant is preferably dispersed therein because the toner constituents solution or dispersion is stably dispersed therein and the resultant toner has a sharp particle diameter distribution.

Specific examples of the dispersant include a surfactant, an inorganic dispersant hardly soluble in water, a polymer protective colloid, etc. These can be used alone or in combination, and the surfactant is preferably used.

The surfactants include anionic surfactants, cationic surfactants, nonionic surfactants, ampholytic surfactants, etc.

Specific examples of the anionic surfactants include an alkylbenzene sulfonic acid salt, an α-olefin sulfonic acid salt, a phosphoric acid salt, etc., and anionic surfactants having a fluoroalkyl group are preferably used. Specific examples thereof include fluoroalkyl carboxylic acids having from 2 to 10 carbon atoms and their metal salts, disodium perfluorooctanesulfonylglutamate, sodium 3-{omega-fluoroalkyl(C6-C11)oxy}-1-alkyl(C3-C4)sulfonate, sodium 3-{omega-fluoroalkanoyl(C6-C8)-N-ethylamino}-1-propanesulfonate, fluoroalkyl(C11-C20) carboxylic acids and their metal salts, perfluoroalkylcarboxylic acids and their metal salts, perfluoroalkyl(C4-C12)sulfonate and their metal salts, perfluorooctanesulfonic acid diethanol amides, N-propyl-N-(2-hydroxyethyl)perfluorooctanesulfone amide, perfluoroalkyl(C6-C10)sulfoneamidepropyltrimethylammonium salts, salts of perfluoroalkyl(C6-C10)-N-ethylsulfonylglycin, monoperfluoroalkyl(C6-C16)ethylphosphates, etc. Specific examples of the marketed products of such surfactants include SARFRON S-111, S-112 and S-113, which are manufactured by Asahi Glass Co., Ltd.; FLUORAD FC-93, FC-95, FC-98 and FC-129, which are manufactured by Sumitomo 3M Ltd.; UNIDYNE DS-101 and DS-102, which are manufactured by Daikin Industries, Ltd.; MEGAFACE F-110, F-120, F-113, F-191, F-812 and F-833 which are manufactured by Dainippon Ink and Chemicals, Inc.; ECTOP EF-102, 103, 104, 105, 112, 123A, 306A, 501, 201 and 204, which are manufactured by Tohchem Products Co., Ltd.; FUTARGENT F-100and F150 manufactured by Neos; etc.

Specific examples of the cationic surfactants include amine salts such as an alkyl amine salt, an aminoalcohol fatty acid derivative, a polyamine fatty acid derivative and an imidazoline; and quaternary ammonium salts such as an alkyltrimethyl ammonium salt, a dialkyldimethyl ammonium salt, an alkyldimethyl benzyl ammonium salt, a pyridinium salt, an alkyl isoquinolinium salt and a benzethonium chloride. Among the cationic surfactants, primary, secondary and tertiary aliphatic amines having a fluoroalkyl group, aliphatic quaternary ammonium salts such as perfluoroalkyl(C6-C10)sulfoneamidepropyltrimethylammonium salts, benzalkonium salts, benzetonium chloride, pyridinium salts, imidazolinium salts, etc. are preferably used. Specific examples of the marketed products thereof include SARFRON S-121 (from Asahi Glass Co., Ltd.); FLUORAD FC-135 (from Sumitomo 3M Ltd.); UNIDYNE DS-202 (from Daikin Industries, Ltd.); MEGAFACE F-150 and F-824 (from Dainippon Ink and Chemicals, Inc.); ECTOP EF-132 (from Tohchem Products Co., Ltd.); FUTARGENT F-300 (from Neos); etc.

Specific examples of the nonionic surfactants include a fatty acid amide derivative, a polyhydric alcohol derivative, etc.

Specific examples of the ampholytic surfactants include alanine, dodecyldi(aminoethyl)glycin, di(octylaminoethyle)glycin, and N-alkyl-N,N-dimethylammonium betaine, etc.

Specific examples of the inorganic surfactants hardly soluble in water include tricalcium phosphate, calcium carbonate, colloidal titanium oxide, colloidal silica, and hydroxyapatite.

Specific examples of the protective colloids include polymers and copolymers prepared using monomers such as acids (e.g., acrylic acid, methacrylic acid, α-cyanoacrylic acid, α-cyanomethacrylic acid, itaconic acid, crotonic acid, fumaric acid, maleic acid and maleic anhydride), acrylic monomers having a hydroxyl group (e.g., β-hydroxyethyl acrylate, β-hydroxyethyl methacrylate, β-hydroxypropyl acrylate, β-hydroxypropyl methacrylate, γ-hydroxypropyl acrylate, γ-hydroxypropyl methacrylate, 3-chloro-2-hydroxypropyl acrylate, 3-chloro-2-hydroxypropyl methacrylate, diethyleneglycolmonoacrylic acid esters, diethyleneglycolmonomethacrylic acid esters, glycerinmonoacrylic acid esters, N-methylolacrylamide and N-methylolmethacrylamide), vinyl alcohol and its ethers (e.g., vinyl methyl ether, vinyl ethyl ether and vinyl propyl ether), esters of vinyl alcohol with a compound having a carboxyl group (i.e., vinyl acetate, vinyl propionate and vinyl butyrate); acrylic amides (e.g, acrylamide, methacrylamide and diacetoneacrylamide) and their methylol compounds, acid chlorides (e.g., acrylic acid chloride and methacrylic acid chloride), and monomers having a nitrogen atom or an alicyclic ring having a nitrogen atom (e.g., vinyl pyridine, vinyl pyrrolidone, vinyl imidazole and ethylene imine). In addition, polymers such as polyoxyethylene compounds (e.g., polyoxyethylene, polyoxypropylene, polyoxyethylenealkyl amines, polyoxypropylenealkyl amines, polyoxyethylenealkyl amides, polyoxypropylenealkyl amides, polyoxyethylene nonylphenyl ethers, polyoxyethylene laurylphenyl ethers, polyoxyethylene stearylphenyl esters, and polyoxyethylene nonylphenyl esters); and cellulose compounds such as methyl cellulose, hydroxyethyl cellulose and hydroxypropyl cellulose, can also be used as the polymeric protective colloid.

In addition to the dispersants, a dispersion stabilizer is optionally used. Specific examples thereof include acid and alkali-soluble materials such as calcium phosphate. It is preferable to dissolve the dispersant with hydrochloric acid to remove that from the toner particles, followed by washing. In addition, it is possible to remove such a dispersant by decomposing the dispersant using an enzyme.

In addition, known catalysts such as dibutyltin laurate and dioctyltin laurate can be used for the elongation and crosslinking reaction, if desired.

The organic solvent is removed from the dispersion (emulsified slurry) by a method of gradually heating the dispersion to completely evaporate the organic solvent in the oil drop or a method of spraying the emulsified dispersion in a dry atmosphere to completely evaporate the organic solvent in the oil drop and to evaporate the aqueous dispersant, etc.

When removed, mother toner particles are formed. The mother toner particles are washed, dried and further classified if desired. The mother toner particles are classified by removing fine particles with a cyclone, a decanter, a centrifugal separator, etc. in the dispersion. Alternatively, the mother toner particles may be classified as a powder after dried.

The thus prepared dry mother toner particles can be mixed with one or more other particulate materials such as external additives mentioned above, release agents, charge controlling agents, fluidizers and colorants optionally upon application of mechanical impact thereto to fix the particulate materials on the mother toner particles.

Specific examples of such mechanical impact application methods include methods in which a mixture is mixed with a highly rotated blade and methods in which a mixture is put into a jet air to collide the particles against each other or a collision plate. Specific examples of such mechanical impact applicators include ONG MILL (manufactured by Hosokawa Micron Co., Ltd.), modified I TYPE MILL in which the pressure of air used for pulverizing is reduced (manufactured by Nippon Pneumatic Mfg. Co., Ltd.), HYBRIDIZATION SYSTEM (manufactured by Nara Machine Co., Ltd.), KRYPTRON SYSTEM (manufactured by Kawasaki Heavy Industries, Ltd.), automatic mortars, etc.

The toner of the present invention is prepared by the method of preparing toner of the present invention.

The toner of the present invention, having a smooth surface, has good transferability and chargeability and produces high-quality images. Further, the toner of the present invention, including an adhesive base material formed by reacting a compound having an active hydrogen and a polymer reactable with the active hydrogen, has even better transferability and fixability. Therefore, the toner of the present invention can be used in various fields and preferably used in electrophotographic image formation.

The toner of the present invention preferably has a volume-average particle diameter (Dv) of from 3 to 8 μm, and more preferably from 4 to 7 μm.

When less than 3 μm, the toner is fusion-bonded to the surface of a carrier when used in a two-component developer, resulting in deterioration of the chargeability of the carrier, and filming thereof over a developing roller and fusion bond thereof to a blade forming a thin layer thereof tend to occur when used as a one-component developer. When greater than 8 μm, the toner is difficult to produce high definition and high-quality images, and largely varies in the particle diameter when the toner is consumed and fed in the developer. The toner of the present invention preferably has a ratio (Dv/Dn) of the volume-average particle diameter (Dv) to a number-average particle diameter (Dn) of from 1.00 to 1.25, and more preferably of from to 1.05 to 1.25. Such a toner, when used in a two-component developer, has less variation of its particle diameter in the developer even after the toner is consumed and fed for long periods, and has good and stable developability even after stirred in an image developer for long periods. When greater than 1.25, the toner is difficult to produce high definition and high-quality images, and largely varies in the particle diameter when the toner is consumed and fed in the developer.

The (Dv) and the ratio (Dv)/(Dn) can be measured by MULTISIZER III from Beckman Coulter, Inc. as follows:

0.1 to 5 ml of a detergent, preferably alkylbenzene sulfonate is included as a dispersant in 100 to 150 ml of the electrolyte ISOTON R-II from Coulter Scientific Japan, Ltd., which is a NaCl aqueous solution including an elemental sodium content of 1%;

2 to 20 mg of a toner sample is included in the electrolyte to be suspended therein, and the suspended toner is dispersed by an ultrasonic disperser for about 1 to 3 min to prepare a sample dispersion liquid; and

a volume and a number of the toner particles for each of the following channels are measured by the above-mentioned measurer using an aperture of 100 μm to determine a weight distribution and a number distribution:

2.00 to 2.52 μm; 2.52 to 3.17 μm; 3.17 to 4.00 μm; 4.00 to 5.04 μm; 5.04 to 6.35 μm; 6.35 to 8.00 μm; 8.00 to 10.08 μm; 10.08 to 12.70 μm; 12.70 to 16.00 μm; 16.00 to 20.20 μm; 20.20 to 25.40 μm; 25.40 to 32.00 μm; and 32.00 to 40.30 μm.

The toner of the present invention preferably has an average circularity of from 0.94 to 9.97. The average circularity is determined by dividing a circumferential length of a circle having an area equivalent to a projected area of the toner with a length of the actual particle. The toner preferably includes particles having a circularity less than 0.94 in an amount not greater than 15% by number. When less than 0.94, the toner has difficulty in having sufficient transferability and producing high-quality images without a toner dust. When greater than 0.97, an image forming apparatus using blade cleaning has poor cleaning on a photoreceptor and a transfer belt. For example, when images having a large image area such as photo images are produced, untransferred toner occasionally remains on the photoreceptor, resulting in background fouling and contamination of a charging roller.

The average circularity of the toner can be measured by an optical detection method of passing a suspension including a particle through a tabular imaging detector and optically detecting and analyzing the particle image with a CCD camera is suitably used, such as a flow-type particle image analyzer FPIA-2000 from SYSMEX CORPORATION.

Images produced by the toner of the present invention preferably have an image density not less than 1.40, more preferably not less than 1.45, and even more preferably not less than 1.50 when measured by a spectrometer SPECTRODENSITOMETER 938 from X-Rite. A high-quality image has an image density not less than 1.40. For example, a modified tandem full-color image forming apparatus IPSiO Color 8100 from Ricoh Company, Ltd. forms a solid image with a developer in an adhered amount of 1.00±0.01 mg/cm² on a copy paper TYPE6200from Ricoh Company, Ltd. at a surface temperature of 150±2° C. of the fixing roller, and an average of image density of random 5 parts of the solid image, measured by the spectrometer, is determined as the image density.

The developer of the present invention includes at least the toner of the present invention, and optionally other components such as a carrier. Therefore, the developer has good transferability and chargeability, and produces high-quality images.

The developer of the present invention has less variation of particle diameter of the toner even after repeatedly used, good and stable developability and produces quality images for long periods.

The carrier is not particularly limited, and can be selected in accordance with the purpose, however, preferably includes a core material and a resin layer coating the core material.

The core material is not particularly limited, and can be selected from known materials such as Mn—Sr materials and Mn-Mg materials having 50 to 90 emu/g; and highly magnetized materials such as iron powders having not less than 100 emu/g and magnetite having 75 to 120 emu/g for image density. In addition, light magnetized materials such as Cu—Zn materials having 30 to 80 emu/g are preferably used to decrease a stress to a photoreceptor having toner ears for high-quality images. These can be used alone or in combination.

The core material preferably has a volume-average particle diameter of from 10 to 150 μm, and more preferably from 40 to 100 μm. When less than 10 μm, a magnetization per particle is so low that the carrier scatters. When larger than 150 μm, a specific surface area lowers and the toner occasionally scatters, and a solid image of a full-color image occasionally has poor reproducibility.

The resin coating the core material is not particularly limited, and can be selected in accordance with the purpose. Specific examples of the resin include amino resins, polyvinyl resins, polystyrene resins, halogenated olefin resins, polyester resins, polycarbonate resins, polyethylene resins, polyvinyl fluoride resins, polyvinylidene fluoride resins, polytrifluoroethylene resins, polyhexafluoropropylene resins, vinylidenefluoride-acrylate copolymers, vinylidenefluoride-vinylfluoride copolymers, copolymers of tetrafluoroethylene, vinylidenefluoride and other monomers including no fluorine atom, and silicone resins. These can be used alone or in combination.

Specific examples of the amino resins include urea-formaldehyde resins, melamine resins, benzoguanamine resins, urea resins, polyamide resins, epoxy resins, etc. Specific examples of the polyvinyl resins include acrylic resins, polymethylmethacrylate resins, polyacrylonitirile resins, polyvinyl acetate resins, polyvinyl alcohol resins, polyvinyl butyral resins, etc. Specific examples of the polystyrene resins include polystyrene resins, styrene-acrylic copolymers, etc. Specific examples of the halogenated olefin resins include polyvinyl chloride resins, etc. Specific examples of the polyester resins include polyethyleneterephthalate resins, polybutyleneterephthalate resins, etc.

An electroconductive powder may optionally be included in the toner. Specific examples of such electroconductive powders include, but are not limited to, metal powders, carbon blacks, titanium oxide, tin oxide, and zinc oxide. The average particle diameter of such electroconductive powders is preferably not greater than 1 μm. When the particle diameter is too large, it is hard to control the resistance of the resultant toner.

The resin layer can be formed by preparing a coating liquid including a solvent and, e.g., the silicone resin; uniformly coating the liquid on the surface of the core material by a known coating method; and drying the liquid and burning the surface thereof. The coating method includes dip coating methods, spray coating methods, brush coating method, etc. Specific examples of the solvent include, but are not limited to, toluene, xylene, methyl ethyl ketone, methyl isobutyl ketone, cellosolve butyl acetate, etc. Specific examples of the burning methods include, but are not limited to, externally heating methods or internally heating methods using fixed electric ovens, fluidized electric ovens, rotary electric ovens, burner ovens, microwaves, etc.

The carrier preferably includes the resin layer in an amount of from 0.01 to 5.0% by weight. When less than 0.01% by weight, a uniform resin layer cannot be formed on the core material. When greater than 5.0% by weight, the resin layer becomes so thick that carrier particles granulate one another and uniform carrier particles cannot be formed.

The two-component developer preferably includes the carrier in an amount of from 90 to 98% by weight, and more preferably from 90 to 97% by weight.

The toner container of the present invention contains the toner or the developer of the present invention.

The container is not particularly limited, and can be selected from known containers such as a container having a cap.

The size, shape, structure, material, etc. thereof are not particularly limited, and can be selected in accordance with the purpose. The container preferably has the shape of a cylinder, and particularly, the cylinder preferably has a spiral concavity and convexity on the inside surface thereof such that a toner can transfer to an exit thereof when the cylinder rotates. In addition, apart or the all of the spiral is preferably a cornice.

The materials for the container are not particularly limited, and resins having good size precision are preferably used, such as polyester resins, polyethylene resins, polypropylene resins, polystyrene resins, polyvinylchloride resins, polyacrylate resins, polycarbonate resins, ABS resins and polyacetal resins.

The toner container of the present invention is easy to store, transport and handle, and is detachable from a process cartridge and an image forming apparatus to feed the toner thereto.

The process cartridge of the present invention includes at least an image developer including the developer of the present invention and an image bearer, and may optionally include other means. Then, an electrostatic latent image borne on the image bearer is developed with the developer to form a visual image.

The image developer preferably includes the toner container of the present invention and a developer bearer bearing and conveying the developer, and may include a layer thickness regulation member regulating the thickness of a toner layer.

The process cartridge of the present invention is detachable from an image forming apparatus.

The image forming method of the present invention efficiently produces high-quality images, using the developer of the present invention.

The image forming method of the present invention includes at least an electrostatic latent image forming process, a development process, a transfer process and a fixing process; and optionally includes other processes such as a discharge process, a cleaning process, a recycle process and a control process.

The image forming apparatus of the present invention includes at least an electrostatic latent image bearer, an electrostatic latent image former, an image developer, a transferer and a fixer, and optionally includes other means such as a discharger, a cleaner, a recycler and a controller.

The electrostatic latent image forming process is a process of forming an electrostatic latent image on an electrostatic latent image bearer. The material, shape, structure, size, etc. of the electrostatic latent image bearer (a photoreceptor) are not particularly limited, and can be selected from known electrostatic latent image bearers. However, the electrostatic latent image bearer preferably has the shape of a drum, and the material is preferably an inorganic material such as amorphous silicon and serene. The electrostatic latent image is formed by uniformly charging the surface of the electrostatic latent image bearer and irradiating imagewise light onto the surface thereof with the electrostatic latent image former. The electrostatic latent image former includes at least a charger uniformly charging the surface of the electrostatic latent image bearer and an irradiator irradiating imagewise light onto the surface thereof.

The surface of the electrostatic latent image bearer is charged with the charger upon application of voltage. The charger is not particularly limited, and can be selected in accordance with the purpose, such as an electroconductive or semiconductive rollers, bushes, films, known contact chargers with a rubber blade, and non-contact chargers using a corona discharge such as corotron and scorotron.

The surface of the electrostatic latent image bearer is irradiated with the imagewise light by the irradiator. The irradiator is not particularly limited, and can be selected in accordance with the purpose, provided that the irradiator can irradiate the surface of the electrostatic latent image bearer with the imagewise light, such as reprographic optical irradiators, rod lens array irradiators, laser optical irradiators and a liquid crystal shutter optical irradiators. In the present invention, a backside irradiation method irradiating the surface of the electrostatic latent image bearer through the backside thereof may be used.

The development process is a process of forming a visual image by developing the electrostatic latent image with the toner or the developer of the present invention. The image developer is not particularly limited, and can be selected from known image developers, provided that the image developer can develop with the toner or developer of the present invention. For example, an image developer containing the toner or developer of the present invention and being capable of feeding the toner or developer to the electrostatic latent image while contacting or not contacting thereto is preferably used, and an image developer including the above-mentioned toner container is more preferably used. The image developer includes a discharge pore, discharge conveyor and collector to discharge an extra overflowed developer.

In the image developer including a two-component developer, the toner and the carrier are mixed and stirred, and the toner is charged and held on the surface of the rotatable magnet roller in the shape of an ear to form a magnetic brush. Since the magnet roller is located close to the electrostatic latent image bearer (photoreceptor), a part of the toner is electrically attracted to the surface thereof. Consequently, the electrostatic latent image is developed with the toner to form a visual image thereon.

The transfer process is a process of transferring the visual image onto a recording medium, and it is preferable that the visual image is firstly transferred onto an intermediate transferer and secondly transferred onto a recording medium thereby. It is more preferable that two or more visual color images are firstly and sequentially transferred onto the intermediate transferer and the resultant complex full-color image is transferred onto the recording medium thereby.

The visual image is transferred by the transferer using a transfer charger charging the electrostatic latent image bearer (photoreceptor). The transferer preferably includes a first transferer transferring the two or more visual color images onto the intermediate transferer and a second transferer transferring the resultant complex full-color image onto the recording medium. The intermediate transferer is not particularly limited, and can be selected from known transferers in accordance with the purpose, such as a transfer belt.

Each of the first and second transferers is preferably at least a transferee chargeable to separate the visual image from the electrostatic latent image bearer (photoreceptor) toward the recoding medium. The transferer may be one, or two or more. The transferer includes a corona transferer using a corona discharge, a transfer belt, a transfer roller, a pressure transfer roller, an adhesive roller, etc. The recording medium is not particularly limited, and can be selected from known recording media (paper).

The visual image transferred onto the recording medium is fixed thereon by a fixer. Each color toner image or the resultant complex full-color image may be fixed thereon. The fixer is not particularly limited, can be selected in accordance with the purpose, and known heating and pressurizing means are preferably used. The heating and pressurizing means include a combination of a heating roller and a pressure roller, and a combination of a heating roller, a pressure roller and an endless belt, etc. The heating temperature is preferably from 80 to 200° C. In the present invention, a known optical fixer may be used with or instead of the fixer in accordance with the purpose.

The electrostatic latent image bearer is discharged by the discharger upon application of discharge bias. The discharger is not particularly limited, and can be selected from known dischargers, provide that the discharger can apply the discharge bias to the electrostatic latent image bearer, such as a discharge lamp.

The toner remaining on the electrostatic latent image bearer is preferably removed by the cleaner. The cleaner is not particularly limited, and can be selected from known cleaners, provide that the cleaner can remove the toner remaining thereon, such as a magnetic brush cleaner, an electrostatic brush cleaner, a magnetic roller cleaner, a blade cleaner, a brush cleaner and a web cleaner.

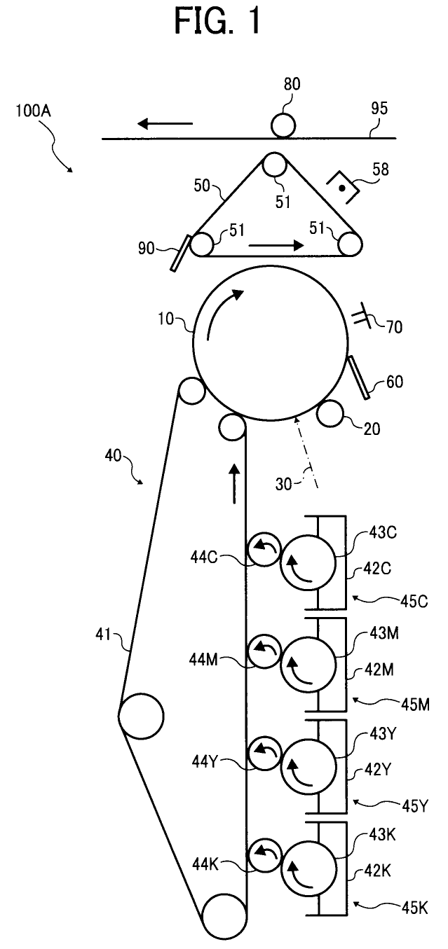

FIG. 1 is a schematic view illustrating an embodiment of the image forming apparatus for use in the present invention. An image forming apparatus 100A therein includes a drum-shaped photoreceptor 10 as an image bearer, a charging roller as a charger 20, an irradiator 30, an image developer 40, an intermediate transferer 50, a cleaner 60 having a cleaning blade and a discharge lamp 70 as a discharger.

The intermediate transferer 50 is an endless belt suspended and extended by here rollers 51, and is transportable in the direction indicated by an arrow. The three rollers 51 partly work as a transfer bias roller capable of applying a predetermined first transfer bias to the intermediate transferer 50. A cleaner 90 having a cleaning blade is located close thereto and a transfer roller 80 capable of applying a transfer bias to a transfer paper 95 as a final transfer material to transfer (second transfer) the toner image thereon is located at the other side of the transfer paper 9. Around the intermediate transferer 50, a corona charger 58 charging the toner image thereon is located between a contact point of the photoreceptor 10 and the intermediate transferer 50 and a contact point of the intermediate transferer 50 and a transfer paper 95 in the rotating direction of the intermediate transferer 50.

The image developer 40 includes a developing belt 41 as a developer bearer, a black developing unit 45K, a yellow developing unit 45Y, a magenta developing unit 45M and a cyan developing unit 45C around the developing belt 41. The black developing unit 45K includes a developer container 42K, a developer feed roller 43K and a developing roller 44K; the yellow developing unit 45Y includes a developer container 42Y, a developer feed roller 43Y and a developing roller 44Y; the magenta developing unit 45M includes a developer container 42M, a developer feed roller 43M and a developing roller 44M; and the cyan developing unit 45C includes a developer container 42C, a developer feed roller 43C and a developing roller 44C. The developing belt 41 is an endless belt rotatably suspended and extended by plural rollers, and partly contacts the photoreceptor 10.

The charging roller 20 uniformly charges the photoreceptor 10. The irradiator 30 irradiates imagewise light to the photoreceptor 10 to form an electrostatic latent image thereon. The electrostatic latent image formed thereon is developed with a toner fed from the image developer 40 to form a visible image (toner image) thereon. The visible image (toner image) is transferred (first transfer) onto the intermediate transferer 50 with a voltage applied from the roller 51, and is further transferred (second transfer) onto a transfer paper 95. The toner remaining on the photoreceptor 10 is removed by a cleaner 60, and the photoreceptor 10 is discharged by the discharge lamp 70.

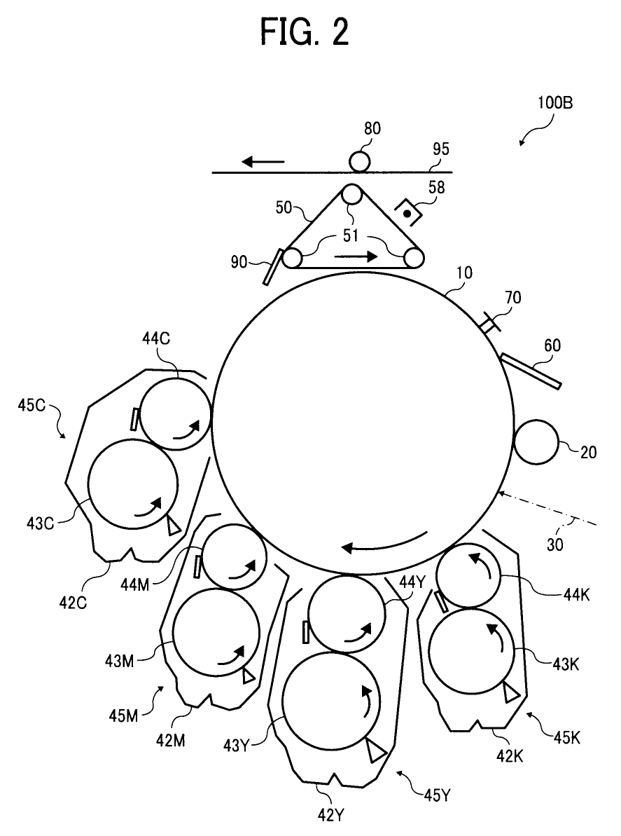

FIG. 2 is a schematic view illustrating another embodiment of the image forming apparatus of the present invention. An image forming apparatus 100B therein has the same constitutions as that of FIG. 2 except that the developing belt 41 is not located and the black developing unit 45K, yellow developing unit 45Y, magenta developing unit 45M and cyan developing unit 45C are located around the photoreceptor 10, facing thereto. The same elements therein have the same numbers as those in FIG. 1.

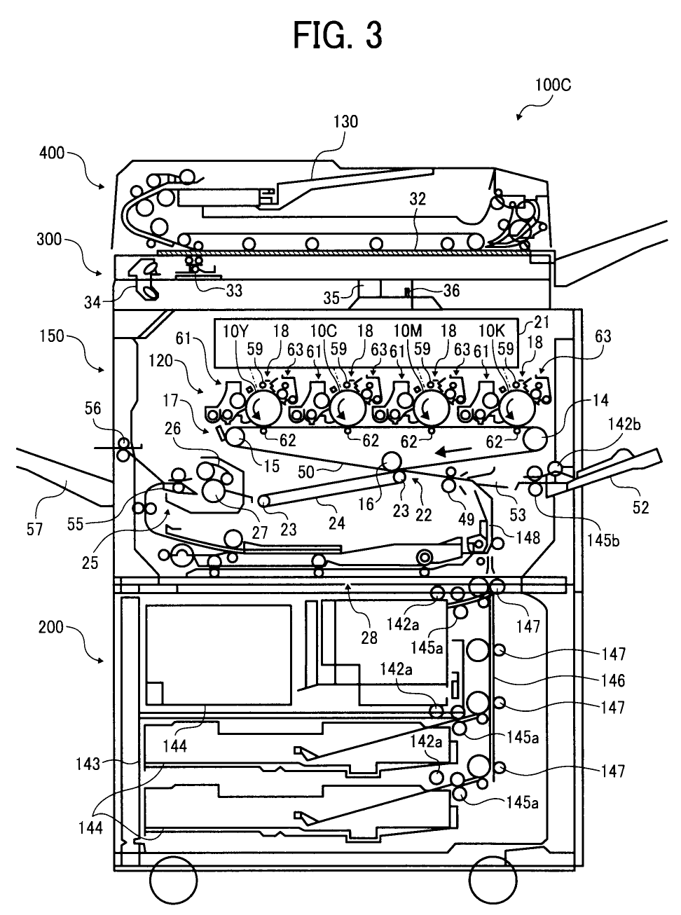

FIG. 3 is a schematic view illustrating a further embodiment of the image forming apparatus for use in the present invention. The image forming apparatus 100C therein is a tandem full-color image forming apparatus. The image forming apparatus 100C includes a duplicator 150, a paper feeding table 200, a scanner 300 and an automatic document feeder (ADF) 400. The duplicator 150 includes an intermediate transferer 50 having the shape of an endless belt. The intermediate transferer 50 is suspended by three suspension rollers 14, 15 and 16 and rotatable in a clockwise direction. On the left of the suspension roller 15, an intermediate transferer cleaner 17 is located to remove a residual toner on an intermediate transferer 50 after an image is transferred. Above the intermediate transferer 50, four image forming units 18 for yellow, cyan, magenta and black colors are located in line from left to right along a transport direction of the intermediate transferer 50 to form a tandem image forming developer 120. Above the tandem color image developer 120, an irradiator 21 is located. On the opposite side of the tandem color image developer 120 across the intermediate transferer 50, a second transferer 22 is located. The second transferer 22 includes a an endless second transfer belt 24 and two rollers 23 suspending the endless second transfer belt 24, and is pressed against the suspension roller 16 across the intermediate transferer 50 and transfers an image thereon onto a sheet. Beside the second transferer 22, a fixer 25 fixing a transferred image on the sheet is located. The fixer 25 includes a an endless fixing belt 26 and a pressure roller 27 pressing the fixing belt 26.

Below the second transferer 22 and the fixer 25, a sheet reverser 28 reversing the sheet to form an image on both sides thereof is located in the tandem color image forming apparatus 100C.

Next, full-color image formation using a tandem image developer 120 will be explained. An original is set on a table 130 of the ADF 400 to make a copy, or on a contact glass 32 of the scanner 300 and pressed with the ADF 400.

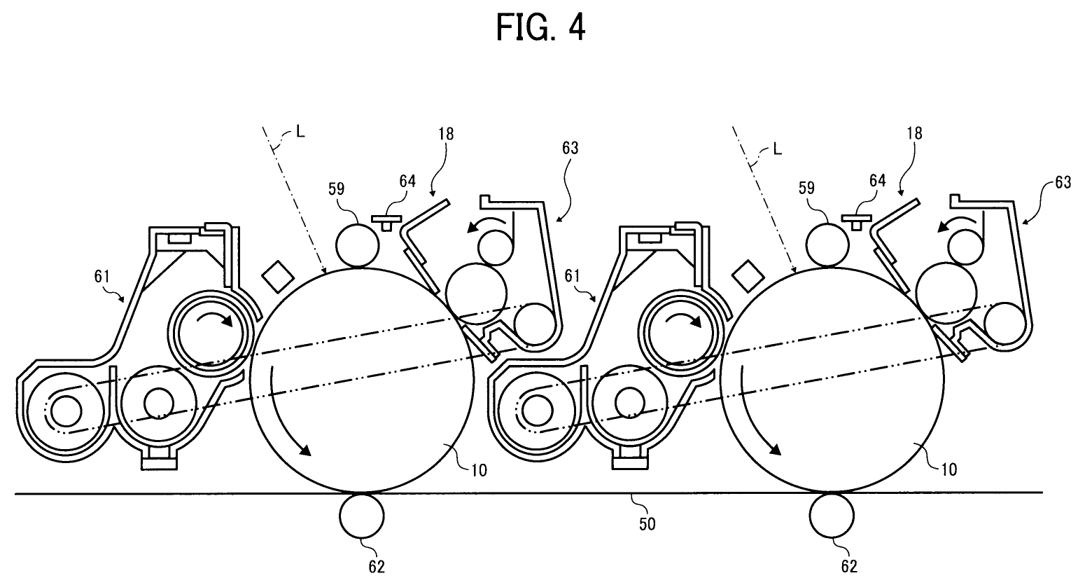

When a start switch (not shown) is put on, a first scanner 33 and a second scanner 34 scans the original after the original set on the table 30 of the ADF 400 is fed onto the contact glass 32 of the scanner 300, or immediately when the original set thereon. The first scanner 33 emits light to the original and reflects reflected light therefrom to the second scanner 34. The second scanner further reflects the reflected light to a reading sensor 36 through an imaging lens 35 to read the color original (color image) as image information of black, yellow, magenta and cyan. The black, yellow, magenta and cyan image information are transmitted to each image forming units 18, i.e., a black image forming unit, a yellow image forming unit, a magenta image forming unit and a cyan image forming unit in the tandem image developer 120 respectively, and the respective image forming units form a black toner image, a yellow toner image, a magenta toner image and a cyan toner image. Namely, each of the image forming units 18 in the tandem image developer 120 includes, as shown in FIG. 4, a photoreceptor 10, i.e., a photoreceptor for black 10K, a photoreceptor for yellow 10Y, a photoreceptor for magenta 10M and a photoreceptor for cyan 10C; a charger 59 uniformly charging the photoreceptor; an irradiator irradiating the photoreceptor with imagewise light (L in FIG. 4) based on each color image information to form an electrostatic latent image thereon; an image developer 61 developing the electrostatic latent image with each color toner, i.e., a black toner, a yellow toner, a magenta toner and a cyan toner to form a toner image thereon; a transfer charger 62 transferring the toner image onto an intermediate transferer 50; a photoreceptor cleaner 63; and a discharger 64.

On the other hand, when start switch (not shown) is put on, one of paper feeding rollers 142a of the paper feeding table 200 is selectively rotated to take a sheet out of one of multiple-stage paper cassettes 144 in a paper bank 143. A separation roller 145a separates sheets one by one and feed the sheet into a paper feeding route 146, and a feeding roller 147 feeds the sheet into a paper feeding route 148 to be stopped against a registration roller 49. Alternatively, a paper feeding roller 142b is rotated to take a sheet out of a manual feeding tray 51, and a separation roller 145b separates sheets one by one and feed the sheet into a paper feeding route 53 to be stopped against the registration roller 49. The registration roller 49 is typically earthed, and may be biased to remove a paper dust from the sheet.

Then, in timing with a synthesized full-color image on the intermediate transferer 50, the registration roller 49 is rotated to feed the sheet between the intermediate transferer 50 and the second transferer 22, and the second transferer transfers (second transfer) the full-color image onto the sheet. The intermediate transferer 50 after transferring an image is cleaned by the intermediate transferer cleaner 17 to remove a residual toner thereon after the image is transferred.

The sheet the full-color image is transferred on is fed by the second transferer 22 to the fixer 25. The fixer 25 fixes the image thereon upon application of heat and pressure, and the sheet is discharged by a discharge roller 56 onto a catch tray 57 through a switch-over click 55. Alternatively, the switch-over click 55 feeds the sheet into the sheet reverser 28 reversing the sheet to a transfer position again to form an image on the backside of the sheet, and then the sheet is discharged by the discharge roller 56 onto the catch tray 57.

Having generally described this invention, further understanding can be obtained by reference to certain specific examples which are provided herein for the purpose of illustration only and are not intended to be limiting. In the descriptions in the following examples, the numbers represent weight ratios in parts, unless otherwise specified.

### EXAMPLES

### Masterbatch Preparation Example

229 parts of an adduct of bisphenol A with 2 moles of ethyleneoxide, 529 parts of an adduct of bisphenol A with 3 moles of propyleneoxide, 208 parts terephthalic acid, 46 parts of adipic acid and 2 parts of dibutyltinoxide were polycondensated in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs, 44 parts of trimellitic acid anhydride were added thereto and the mixture was reacted for 2 hrs at a normal pressure and 180° C. to prepare an unmodified polyester resin.

The unmodified polyester resin had a number-average molecular weight of 2,500, a weight-average molecular weight of 6,700, a Tg of 43° C. and an acid value of 25 mg KOH/g.

1,200 parts of water, 540 parts of carbon black Printex 35 from Degussa A.G. having a DBP oil absorption of 42 ml/100 mg and a pH of 9.5, 1,200 parts of the unmodified polyester resin were mixed by a Henschel mixer from Mitsui Mining Co., Ltd. After the mixture was kneaded by a two-roll mill having a surface temperature of 150° C. for 30 min, the mixture was extended by applying pressure, cooled and pulverized by a pulverizer from Hosokawa Micron Limited to prepare a masterbatch K.

The procedure of preparation of the masterbatch k was repeated to prepare masterbatches C, M and Y except for replacing carbon black with C.I. Pigment Blue 15:3, Pigment Red 269 and Pigment Yellow 150, respectively.

### Example 1

378 parts of the unmodified polyester resin, 110 parts of carnauba wax and 947 parts of ethyl acetate were mixed in a reaction vessel including a stirrer and a thermometer. The mixture was heated to have a temperature of 80° C. while stirred. After the temperature of 80° C. was maintained for 5 hrs, the mixture was cooled to have a temperature of 30° C. in an hour. Then, 500 parts of the masterbatch K and 500 parts of ethyl acetate were added to the mixture and mixed for 1 hr to prepare a material solution.

1,324 parts of the material solution were transferred into another vessel, and the carbon black and carnauba wax therein were dispersed by a beads mill (Ultra Visco Mill from IMECS CO., LTD.) for 3 passes at a liquid feeding speed of 1 kg/hr and a peripheral disc speed of 6 m/sec using zirconia beads having diameter of 0.5 mm for 80% by volume to prepare a wax dispersion.

Next, 1,324 parts of an ethyl acetate solution of the unmodified polyester resin having a concentration of 65% were added to the wax dispersion. 1.5 parts of an organic-modified layered inorganic mineral Clayton APA from Southern Clay Products, Inc. were added to 200 parts of the wax dispersion subjected to one pass using the Ultra Visco Mill under the same conditions to prepare a mixture. The mixture was stirred at 7,000 rpm for 30 min with T.K. Homodisper from Tokushu Kika Kogyo Co., Ltd. to prepare a toner constituent dispersion.

682 parts of an adduct of bisphenol A with 2 moles of ethyleneoxide, 81 parts of an adduct of bisphenol A with 2 moles of propyleneoxide, 283 parts terephthalic acid, 22 parts of trimellitic acid anhydride and 2 parts of dibutyltinoxide were mixed and reacted in a reactor vessel including a cooling pipe, a stirrer and a nitrogen inlet pipe for 8 hrs at a normal pressure and 230° C. Further, after the mixture was depressurized by 10 to 15 mm Hg and reacted for 5 hrs to prepare an intermediate polyester resin.

The intermediate polyester resin had a number-average molecular weight of 2,100, a weight-average molecular weight of 9,500, a Tg of 55° C. and an acid value of 0.5 mg KOH/g and a hydroxyl value of 51 mg KOH/g.

Next, 410 parts of the intermediate polyester resin, 89 parts of isophoronediisocyanate and 500 parts of ethyl acetate were reacted in a reactor vessel including a cooling pipe, a stirrer and a nitrogen inlet pipe for 5 hrs at 100° C. to prepare a prepolymer. The prepolymer included a free isocyanate in an amount of 1.53% by weight.

170 parts of isophoronediamine and 75 parts of methyl ethyl ketone were reacted at 50° C. for 5 hrs in a reaction vessel including a stirrer and a thermometer to prepare a ketimine compound. The ketimine compound had an amine value of 418 mg KOH/g. 749 parts of the toner constituents dispersion, 115 parts of the prepolymer and 2.9 parts of the ketimine compound were mixed in a vessel by a TK-type homomixer from Tokushu Kika Kogyo Co., Ltd. at 5,000 rpm for 1 min to prepare an oil phase mixed liquid.

683 parts of water, 11 parts of a sodium salt of an adduct of a sulfuric ester with ethyleneoxide methacrylate (ELEMINOL RS-30 from Sanyo Chemical Industries, Ltd.), 83 parts of styrene, 83 parts of methacrylate, 110 parts of butylacrylate and 1 part of persulfate ammonium were mixed in a reactor vessel including a stirrer and a thermometer, and the mixture was stirred for 15 min at 400 rpm to prepare a white emulsion therein. The white emulsion was heated to have a temperature of 75° C. and reacted for 5hrs. Further, 30 parts of an aqueous solution of persulfate ammonium having a concentration of 1% were added thereto and the mixture was reacted for 5 hrs at 75° C. to prepare a particulate resin dispersion.

The volume-average particle diameter of the particulate resin included in particulate resin dispersion was 105 nm when measured by MICROTRAC ultra fine particle diameter distribution measurer UPA-EX150 using laser Doppler method from Nikkiso Co., Ltd. In addition, the particulate resin dispersion was partly dried to isolate the resin, and the resin had a glass transition temperature of 59° C. and weight-average molecular weight of 150,000.

990 parts of water, 83 parts of the [particulate dispersion liquid], 37 parts of an aqueous solution of sodium dodecyldiphenyletherdisulfonate having a concentration of 48.5% (ELEMINOL MON-7 from Sanyo Chemical Industries, Ltd.), 135 parts of an aqueous solution having a concentration of 1% by weight of a polymer dispersant carboxymethylcellulose sodium Selogen BS-H-3 from DAI-ICHI KOGYO SEIYAKU CO., LTD. and 90 parts of ethyl acetate were mixed and stirred to prepare an aqueous medium.

867 parts of the oil phase mixed liquid was added to 1,200 parts of the aqueous medium and mixed therewith by a TK-type homomixer at 13,000 rpm for 20 min to prepare an emulsion slurry.

Next, the emulsion slurry was placed in a vessel including a stirrer and a thermometer. After a solvent was removed from the emulsion slurry at 30° C. for 8 hrs, it was aged at 45° C. for 4 hrs to prepare a dispersion slurry.

The dispersion slurry had a volume-average particle diameter of 5.1 μm and a number-average particle diameter of 4.9 μm when measured by MULTISIZER III from Beckman Coulter, Inc.

After 100 parts of the dispersion slurry was filtered under reduced pressure, 100 parts of ion-exchange water were added to the resultant filtered cake and mixed by the TK-type homomixer at 12,000 rpm for 10 min, and the mixture was filtered.

A hydrochloric acid having a concentration of 10% by weight was added to the filtered cake to have a pH of 3.7 and mixed by the TK-type homomixer at 12,000 rpm for 10 min, and the mixture was filtered.

Further, 300 parts of ion-exchange water were added to the filtered cake and mixed by the TK-type homomixer at 12,000 rpm for 10 min, and the mixture was filtered twice to prepare a final filtered cake.

The final filtered cake was dried by an air drier at 45° C. for 48 hrs and sieved by a mesh having an opening of 75 μm to prepare a mother toner particle.

1.5 part of hydrophobic silica and 0.7 parts of hydrophobized titanium oxide were mixed with 100 parts of the mother toner particle by Henschel Mixer (from Mitsui Mining Co., Ltd.) to prepare a toner K-1.

The procedure for preparation of the toner K-1 was repeated to prepare a toner C-1 except for replacing the masterbatch K with the masterbatch C.

The procedure for preparation of the toner K-1 was repeated to prepare a toner M-1 except for replacing the masterbatch K with the masterbatch M and changing the content of the organic-modified layered inorganic mineral Clayton APA from Southern Clay Products, Inc. from 1.5 to 1.0 parts.

The procedure for preparation of the toner K-1 was repeated to prepare a toner Y-1 except for replacing the masterbatch K with the masterbatch Y and changing the content of the organic-modified layered inorganic mineral Clayton APA from Southern Clay Products, Inc. from 1.5 to 1.0 parts.

### Carrier Preparation Example

The following materials were dispersed with a homomixer for 10 min to prepare a silicone-resin-containing layer coating liquid.

| | |
|---|---|
| Silicone resin solution | 432.2 |
| (solid content of 20% by weight | |
| of SR2410 from Dow Corning Toray | |
| Silicone Co., Ltd.) | |
| Aminosilane | 1.50 |
| (solid content of 100% by weight | |
| of SH6020 from Dow Corning Toray | |
| Silicone Co., Ltd.) | |
| Electroconductive inorganic oxide | 110 |
| EC-700 from Titan Kogyo Co., Ltd., | |
| having a particle diameter of 0.40 μm, | |
| a true specific gravity of 4.2 g/cm and | |
| a particulate powder specific resistivity of 5 Ω·cm | |
| Toluene | 900 |

The coating liquid solution was coated and dried on 5,000 parts of a calcined ferrite powder having an average particle diameter of 35 μm and a true specific gravity of 5.5 g/cm³ by SPIPA COTA from OKADA SEIKO CO., LTD. at a an inner temperature of 40° C. such that the coated layer has a thickness of 0.30 μm. The resultant carrier material was calcined in an electric oven at 200° C. for 1 hr. After cooled, the carrier material was sieved through openings of 63 μm to prepare a carrier having a D/h of 1.3, a volume resistivity of 13.9 [Log(Ω·cm)] and a magnetization of 68 Am²/kg. The charged quantity of the carrier was controlled by the quantity of the aminosilane such that the developer has a charged quantity of from −35 to −25 μC/g at a room temperature.

The aerated apparent density of each toner and a difference between the maximum and minimum thereof are shown in Table 1.

TABLE 1

| | Aerated Apparent Density |
|---|---|
| Toner K-1 | 0.37 |
| Toner Y-1 | 0.39 |
| Toner M-1 | 0.34 |
| Toner C-1 | 0.38 |
| Max | 0.39 |
| Min | 0.34 |
| Difference | 0.05 |

A developer including a toner and a carrier at a weight ratio of 7/93, respectively was set in an image developer of a process cartridge and was filled in a toner cartridge thereof at a weight ratio of 15/85, respectively.

The process cartridge for each color was set in a modified IPSiO Color 8100 from Ricoh Company, ltd., and 5,000 images having an image area of 5% for each color were produced at a temperature of 15° C. and a Rh of 30%. Then, after 10 solid images having an image area of 100% for each color were produced, a halftone image was produced to visually observe image contamination thereof due to poor cleaning. Then, after the developer was left at a temperature of 32° C. and a Rh of 52% for 72 hrs, an image pattern having identifiable full-color solid image and halftone image was produced. The solid image density was measured by a reflection densitometer and unevenness of the halftone image was visually observed. The results are shown in Table 7.

### Example 2

The procedures for preparation of toners C-1 and M-1 were repeated to prepare toners C-2 and M-2 except for changing the content of the organic-modified layered inorganic mineral Clayton APA from Southern Clay Products, Inc. from 1.5 to 1.2 parts, respectively.

Each of the aerated apparent density of toners K-1, Y-1, M-2 and C-2 and a difference between the maximum and minimum thereof are shown in Table 2.

TABLE 2

| | Aerated Apparent Density |
|---|---|
| Toner K-1 | 0.37 |
| Toner Y-1 | 0.39 |
| Toner M-2 | 0.30 |
| Toner C-2 | 0.40 |
| Max | 0.40 |
| Min | 0.30 |
| Difference | 0.10 |

The procedures for preparation and evaluation of the solid and halftone color images in Example 1 were repeated except for using the toners M-2 and C-2. The results are shown in Table 7.

### Comparative Example 1

The procedure for preparation of toner C-1 was repeated to prepare a toner C-3 except for changing the content of the organic-modified layered inorganic mineral Clayton APA from Southern Clay Products, Inc. from 1.5 to 0.8 parts.

Each of the aerated apparent density of toners K-1, Y-1, M-2 and C-3 and a difference between the maximum and minimum thereof are shown in Table 3.

TABLE 3

| | Aerated Apparent Density |
|---|---|
| Toner K-1 | 0.37 |
| Toner Y-1 | 0.39 |
| Toner M-2 | 0.30 |
| Toner C-3 | 0.43 |
| Max | 0.43 |
| Min | 0.30 |
| Difference | 0.13 |

The procedures for preparation and evaluation of the solid and halftone color images in Example 1 were repeated except for using the toners M-2 and C-3. The results are shown in Table 7.

### Comparative Example 2

The procedures for preparation of toners K-1, Y-1 and M-1 were repeated to prepare toners K-2, Y-2 and M-3 except for changing the contents of the organic-modified layered inorganic mineral Clayton APA from Southern Clay Products, Inc. to 1.0, 1.2 and 0.8 parts, respectively.

Each of the aerated apparent density of toners K-2, Y-2, M-3 and C-3 and a difference between the maximum and minimum thereof are shown in Table 4.

TABLE 4

| | Aerated Apparent Density |
|---|---|
| Toner K-2 | 0.42 |
| Toner Y-2 | 0.37 |
| Toner M-3 | 0.36 |
| Toner C-3 | 0.43 |
| Max | 0.43 |
| Min | 0.36 |
| Difference | 0.07 |

The procedures for preparation and evaluation of the solid and halftone color images in Example 1 were repeated except for using the toners K2, Y2, M-3 and C-3. The results are shown in Table 7.

### Comparative Example 3

The procedure for preparation of toner M-1 was repeated to prepare toner M-4 except for changing the content of the organic-modified layered inorganic mineral Clayton APA from Southern Clay Products, Inc. to 1.4 parts.

Each of the aerated apparent density of toners K-1, Y-1, M-4 and C-2 and a difference between the maximum and minimum thereof are shown in Table 5.

TABLE 5

| | Aerated Apparent Density |
|---|---|
| Toner K-1 | 0.37 |
| Toner Y-1 | 0.39 |
| Toner M-4 | 0.28 |
| Toner C-2 | 0.43 |
| Max | 0.40 |
| Min | 0.28 |
| Difference | 0.12 |

The procedures for preparation and evaluation of the solid and halftone color images in Example 1 were repeated except for using the toners M-4 and C-2. The results are shown in Table 7.

### Example 3

The toner Y1 in Example 2 was replaced with the toner Y-2.

Each of the aerated apparent density of toners K-1, Y-2, M-2 and C-2 and a difference between the maximum and minimum thereof are shown in Table 6.

TABLE 6

| | Aerated Apparent Density |
|---|---|
| Toner K-1 | 0.37 |
| Toner Y-2 | 0.37 |
| Toner M-2 | 0.30 |
| Toner C-2 | 0.40 |
| Max | 0.40 |
| Min | 0.30 |
| Difference | 0.10 |

The procedures for preparation and evaluation of the solid and halftone color images in Example 1 were repeated except for using the toners Y-2, M-2 and C-2. The results are shown in Table 7.

TABLE 7

| | Cleanability | | | | | | |
|---|---|---|---|---|---|---|---|
| | at low | After high R/h | | | | | |
| | temperature & | Solid image D* | | | HT* image UE* | | |
| | low R/h | Green | Blue | Red | Green | Blue | Red |
| Example 1 | No abnormal image | 1.50 | 1.50 | 1.50 | Good | Good | Good |
| Example 2 | No abnormal image | 1.48 | 1.49 | 1.51 | Good | Good | Good |
| Example 3 | No abnormal image | 1.49 | 1.45 | 1.48 | Good | Nrml* | Good |
| Comparative | Stripe images | 1.48 | 1.47 | 1.48 | Good | Poor | Good |
| Example 1 | were produced | | | | | | |
| | on cyan color | | | | | | |
| | images due to | | | | | | |
| | poor cleaning | | | | | | |
| Comparative | Stripe images | 1.48 | 1.49 | 1.47 | Good | Good | Good |
| Example 2 | were produced | | | | | | |
| | on black and | | | | | | |
| | cyan color | | | | | | |
| | images due to | | | | | | |
| | poor cleaning | | | | | | |
| Comparative | No abnormal image | 1.49 | 1.50 | 1.51 | Good | Poor | Nrml* |
| Example 3 | | | | | | | |

D: density
HT: halftone
UE: unevenness
Nrml: normal

As Table 7 shows, when the difference between the maximum and minimum aerated apparent densities was not greater than 0.10, the halftone image unevenness was not identifiable. However, when 0.12, unevenness of the blue halftone image overlapping the cyan and magenta color images was identifiable.

When the aerated apparent density was greater than 0.40, abnormal images due to poor cleaning were produced.

This application claims priority and contains subject matter related to Japanese Patent Applications Nos. 2007-308315 and 2008-243705, filed on Nov. 29, 2007 and Sep. 24, 2008, respectively, the entire contents of each of which are hereby incorporated by reference.

Having now fully described the invention, it will be apparent to one of ordinary skill in the art that many changes and modifications can be made thereto without departing from the spirit and scope of the invention as set forth therein.

What is claimed as new and desired to be secured by Letters Patent of the United States is:

1. A full-color image forming method, comprising:
developing an electrostatic latent image with a two-component developer, comprising:
a toner comprising:
a binder resin,
a colorant, and
a layered inorganic mineral in which ions between its layers are at least partially modified with an organic ion; and
a carrier,
wherein the toner comprises a black, a yellow, a magenta and a cyan toner and the carrier is formed of a magnetic particulate material coated with a resin, wherein each of the toners are contained in each toner cartridge comprising the carrier, from which the two-component developer is fed into each image developer developing each of the electrostatic latent image and discharging the extra developer therefrom, and where-n each of the toners has a aerated apparent density not greater than 0.40 and a difference of the aerated apparent density between each of the toners is not greater than 0.10.

2. The full-color image forming method of claim 1, wherein the content of the layered inorganic mineral in the cyan toner is at least larger than that in the magenta toner or in the yellow toner.

3. The full-color image forming method of claim 1, wherein the toner is granulated by dispersing or emulsifying an oil phase or a monomer phase comprising toner constituents comprising a layered inorganic mineral in which ions between its layers are at least partially modified with an organic ion or a precursor of the toner constituents.

4. The full-color image forming method of claim 1, wherein the content of the carrier in the image developer is larger than that in the toner cartridge.

5. The full-color image forming method of claim 1, wherein the two-component developer in the toner cartridge comprises the carrier in an amount of from 5 to 20% by weight.

6. A full-color toner kit, comprising a yellow toner, a magenta toner, a cyan tone rand a black toner, wherein each of the toners comprises:
a binder resin,
a colorant, and
a layered inorganic mineral in which ions between its layers are at least partially modified with an organic ion; and has a aerated apparent density not greater than 0.40 and a difference of the aerated apparent density between each of the toners is not greater than 0.10.
